(19) United States
(12) Patent Application Publication
(10) Pub. No.: US 2009/0212255 A1
(43) Pub. Date: Aug. 27, 2009

(54) Liquid Crystal Composition and Retardation Plate

(75) Inventor: Hideyuki Nishikawa, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/922,594

(22) PCT Filed: Jun. 23, 2006
(86) PCT No.: PCT/JP2006/313161

§ 371 Date: Dec. 20, 2007

(30) Foreign Application Priority Data
Jun. 24, 2005 (JP) 2005-185270

(51) Int. Cl. C09K 19/52; C09K 19/34; G02F 1/1333; G02B 5/30

(52) U.S. Cl. 252/299.61; 252/299.01; 428/336; 349/194

(57) ABSTRACT

A liquid crystal composition is provided and includes a liquid crystal compound a chiral agent. The liquid crystal compound has an intrinsic birefringence Δn(λ) at a wavelength λ satisfying formula (1): Δn(450 nm)/Δn(550 nm)<1.0.

### TECHNICAL FIELD

The present invention relates to a liquid crystal composition and a retardation plate utilizing the same.

### BACKGROUND ART

A rod-shaped liquid crystal compound, being easily controllable in alignment, has been widely employed for example in a retardation plate, and retardation plates utilizing a liquid crystal phase if the rod-shaped liquid crystal with a chiral property have been reported (cf. JP-A-2003-287623). Wavelength dispersions of liquid crystal compounds are generally known to be a normal wavelength dispersion (Δn(450 nm)/Δn(550 nm)>1.0). Therefore, a retardation plate formed with rod-shaped liquid crystal provides a normal wavelength dispersion. For this reason, there has been desired the development of a technology capable of providing an optical element such as a retardation plate, having an inverse wavelength dispersion, in a thin layer and by a simple manufacturing process.

### DISCLOSURE OF INVENTION

An object of an illustrative, non-limiting embodiment of the present invention is to provide a liquid crystal composition having an inverse wavelength dispersion, and also to provide a retardation plate utilizing such liquid crystal composition.

The object above can be accomplished by following means:

(1) A liquid crystal composition comprising: a liquid crystal compound; and a chiral agent, wherein the liquid crystal compound has an intrinsic birefringence Δ(λ) at a wavelength λ, and the intrinsic birefringence Δ(λ) satisfies formula (1):

Δn(450 nm)/Δn(550 nm)<1.0

(2) The liquid crystal composition according to (1), wherein the liquid crystal composition expresses a chiral nematic phase.

(3) The liquid crystal composition according to (1) or (2), wherein the liquid crystal compound is a compound represented by formula (I):

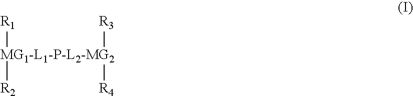

wherein

MG₁ and MG₂ each independently represents a liquid crystal core inducing expression of a liquid crystal phase and comprising two to eight cyclic groups, the two to eight cyclic groups comprising at least one of an aromatic ring, an aliphatic ring and a heterocycle;

R₁, R₂, R₃ and R₄ each independently represents a flexible substituent group, dipole function group or hydrogen bonding group, which is substituted in a molecular longitudinal axial direction of the liquid crystal core and induces expression of the liquid crystal phase;

L₁ and L₂ each independently represents a linkage group substituted on the liquid crystal core MG₁ and is represented by formula (I)-LA or (I)-LB:

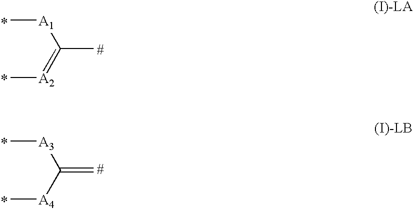

wherein * represents a substituting position on one of the two to eight cyclic groups of MG₁ or MG₂, # represents a connecting position to P, A₁, A₃ and A₄ each independently represents —O—, —NH—, —S—, —CH₂—, —CO—, —SO—, or —SO₂—, A₂ represents —CH═ or —N═;

in a case where both of L₁ and L₂ are represented by the formula (I)-LA, P represents a divalent linkage group selected from the group consisting of —CH═CH—, —C≡C—, 1,4-phenylene and a combination thereof, or a single bond;

in a case where one of L₁ and L₂ is a group represented by the formula (I)-LB and the other of L₁ and L₂ is a group represented by the formula (I)-LA, P represents *═CH—P₁-# or *═N—P₁-#, wherein * indicates a connecting position with the group represented by the formula (I)-LB, # indicates a connecting position with the group represented by the formula (I)-LA, and P₁ represents a divalent linkage group selected from the group consisting of —CH═CH—, —C≡C—, 1,4-phenylene and a combination thereof, or a single bond; and

in a case where both of L₁ and L₂ are represented by the formula (I)-LB, P represents a double bond, ═CH—P₁—CH═, ═N—P₁—CH═, or ═N—P₁—N═.

(4) A retardation plate comprising: a transparent support; and an optically anisotropic layer, wherein the optically anisotropic layer formed from a liquid crystal composition according to any one of (1) to (3).

(5) The retardation plate according to (4), wherein the optically anisotropic layer is formed from the liquid crystal composition in a chiral nematic phase, and the chiral nematic phase has a chiral helical axis substantially perpendicular to a planar direction of the transparent substrate.

(6) The retardation plate according to (4) or (5), wherein the optically anisotropic layer show a selective reflection in a wavelength range of an ultraviolet wavelength region.

(7) The retardation plate according to any one of (4) to (6), wherein the optically anisotropic layer has a film thickness of 0.1 to 20 μm.

The present invention can provide a liquid crystal composition including at least one each of a liquid crystal compound and a chiral agent, and can advantageously provide a liquid crystal composition including at least one each of a liquid crystal compound and a chiral agent, showing a chiral liquid crystal phase and an inverse wavelength dispersion. The present invention can also provide a retardation plate, utilizing such liquid crystal composition. A liquid crystal composition of an exemplary embodiment of the invention can allow to provide an optical element having an inverse wavelength dispersion, such as a wide-band λ/4 plate, that can be realized in a thin layer (for example with a thickness of the optically anisotropic layer of from 0.1 to 20 μm) and by a simple manufacturing process, and a producing method therefor.

### DETAILED DESCRIPTION OF THE INVENTION

### Chiral Agent

A liquid crystal composition of an exemplary embodiment of the invention contains at least a chiral agent.

A chiral agent to be employed in the invention may be one of those already known (for example described in Liquid Crystal Device Handbook, Chapter 3, Item 4-3, chiral agents for TN and STN, p. 199, edited by Japan Society for the Promotion of Science, Committee 142, 1989).

The chiral agent usually contains an asymmetric carbon atom, but an axial asymmetric compound or a planar asymmetric compound, not containing an asymmetric carbon atom, may also be utilized as a chiral agent. Examples of the axial asymmetric compound and the planar asymmetric compound include binaphthyl, helicene, paracyclophane and derivatives thereof.

Also the chiral agent may have a liquid crystalline property, and a liquid crystal compound satisfying the following formula (1) may be used also as the chiral agent

The chiral agent is preferably used in an amount of from 0.001 to 200 mole % with respect to a liquid crystal compound expressing a biaxial nematic phase. The chiral agent is preferably used in a smaller amount, as it generally does not affect the liquid crystalline property. Therefore, a chiral agent having a strong twisting power is preferred. As the chiral agent having such strong twisting power, those described for example in JP-A-2003-287623 may be utilized.

(Liquid Crystal Compound)

A liquid crystal composition of an exemplary embodiment of the invention includes at least a liquid crystal compound of which an intrinsic birefringence Δn(λ) at a wavelength λ satisfies formula (1):

Δn(450 nm)/Δn(550 nm)<1.0 (1)

Liquid crystal compounds do not often have the wavelength dispersion property of Δn represented by the formula (1). In order to express the wavelength dispersion property of Δn represented by the formula (1), it is necessary to suitably adjust at least two absorption wavelengths and a direction of transition moment. As Δn is a difference obtained by subtracting a refractive index for an ordinary light from a refractive index for an extraordinary light, such difference satisfies the formula (1) in case the wavelength dispersion for the ordinary light is more inclined downwards toward right (inclination of Δn in a graphical presentation with a longer wavelength toward the right and a shorter wavelength toward the left) than the wavelength dispersion for the extraordinary light. The wavelength dispersion of the refractive index is closely related with an absorption of the substance as indicated by the Lorentz-Lorenz equation, and, a molecular design providing a longer absorption wavelength in the direction of the ordinary light allows to realize a wavelength dispersion for the ordinary light more inclined downwards toward right, thereby satisfying the relational formula (1).

The direction of the ordinary light is, for example in a rod-shaped liquid crystal, lies in a direction of width of the molecule, and it is generally very difficult to shift a wavelength of an absorptive transition to a longer wavelength, in such width direction of the molecule. A shift to a longer wavelength in an absorptive transition is usually achieved by a method of spreading a π-conjugate system, but such method leads to a larger width of the molecule, thus causing the liquid crystalline property to be lost.

In order to avoid such loss in the liquid crystalline property, there may be employed a method, as reported by William N. Thurms et al. (Liquid Crystals, Vol. 25, p. 149 (1998)), of utilizing a skeletal structure in which two rod-shaped liquid crystal molecules are connected in lateral direction thereof. In such skeletal structure, since two rod-shaped liquid crystal molecules are connected by an ethinyl group, the π-conjugate systems of benzene rings constituting the rod-shaped liquid crystals become conjugated with the π-bond of the ethinyl group (tolan skeleton), whereby the absorption wavelength in the width direction of the molecule can be shifted to a longer wavelength, without deteriorating the liquid crystalline property. However, such tolan skeleton is only inclined by about 60° to a longitudinal axial direction (optical axis direction) of the molecule, stated differently, the direction of absorptive transition is only inclined by about 60°, so that a shift to a longer wavelength takes place not only in the absorbing wavelength in the direction of the ordinary light but also in that in the direction of the extraordinary light, thereby scarcely contributing to the wavelength dispersion property.

It is found that in order to obtain a more inclined shape, downwards toward right, of the wavelength dispersion for the ordinary light only, the direction of absorptive transition is inclined by an angle of preferably from 70 to 90° to the longitudinal axial direction (optical axis direction) of the molecule, more preferably from 80 to 90°. The inclination angle is preferably closer to 90°, as the absorption in the direction of extraordinary light becomes less whereby the wavelength dispersion for the extraordinary light only can be inclined more downwards toward right. Thus, in a preferable molecule, an absorptive transition principally contributing to the refractive index of the ordinary light takes place at a longer wavelength than in an absorptive transition principally contributing to the refractive index of the extraordinary light, and a direction of the absorptive transition principally contributing in the ordinary light is inclined by an angle of from 70 to 90° with respect to the longitudinal axial direction (optical axis direction) of the molecule. In order that the direction of the absorptive transition principally contributing in the ordinary light is inclined by an angle of from 70 to 90° with respect to the longitudinal axial direction (optical axis direction) of the molecule, the molecule preferably includes a partial structure formed by condensing a 6-membered ring and an odd number-membered ring (such as 3-, 5-, 7- or 9-membered ring), and a compound represented by the following formula (I), in which a 6-membered ring and a 5-membered ring are condensed, is particularly preferable:

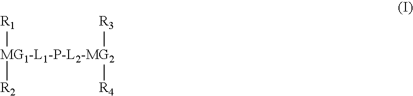

In the formula (I), MG₁ and MG₂ each independently represents a liquid crystal core including two to eight cyclic groups and inducing expression of a liquid crystal phase. The liquid crystal core means, as described in Ekishou Binran (Liquid crystal handbook), 3.2.2 (published by Maruzen, 2000), a rigid part including cyclic groups and linkage parts and necessary for expressing a liquid crystal phase.

Examples of the cyclic group include an aromatic ring, an aliphatic ring and a heterocycle. Examples of the aromatic ring include a benzene ring and a naphthalene ring; those of the aliphatic ring include a cyclohexane ring; and those of the heterocycle include a pyridine ring, a pyrimidine ring, a thiophene ring, a 1,3-dioxane ring, and a 1,3-dithiane ring.

A cyclic group including a benzene ring is preferably 1,4-phenylene. A cyclic group including a naphthalene ring is preferably naphthalene-1,5-diyl or naphthalene-2,6-diyl. A cyclic group including a cyclohexane ring is preferably 1,4-cyclohexylene. A cyclic group including a pyridine ring is preferably pyridine-2,5-diyl. A cyclic group including a pyrimidine ring is preferably pyrimidine-2,5-diyl. A cyclic group including a thiophene ring is preferably thiophene-2,5-diyl. A cyclic group including a 1,3-dioxane ring is preferably 1,3-dioxylene-2,5-diyl. A cyclic group including a 1,3-dithiane ring is preferably 1,3-dithianylene-2,5-diyl.

Examples of a linkage group (the linkage part) linking plural cyclic groups, include a single bond, —CH₂CH₂—, —CH₂—O—, —CH═CH—, —C≡C—, —CH═N—, —N═N—, —CO—O—, —CO—NH—, —CO—S—, and —CH═CH—CO—O—.

For such liquid crystal core including the cyclic groups and the linkage groups, reference may be made to those of liquid crystal compounds, described for example in Ekishou Binran (Liquid crystal handbook) (published by Maruzen, 2000), Liquid Crystal Device Handbook, Chap. 3 (Nikkan Kogyo Shimbun, 1989), Liquid Crystal Materials (Kodansha, 1991), Kagaku Sosetsu No. 22, Chemistry of Liquid Crystals, Chapters 1-7 (The Chemical Society of Japan, 1994), and Handbook of Liquid Crystals, Vols. 2A & 2B (Wiley-VCH, 1998). In particular, a liquid crystal core of a liquid crystal compound, capable of expressing a nematic phase, is preferable.

Examples of MG₁ and MG₂ are shown below, in which ** indicates a connecting position to R₁ or R₂ in case of MG₁, or a connecting position to R₃ or R₄ in case of MG₂.

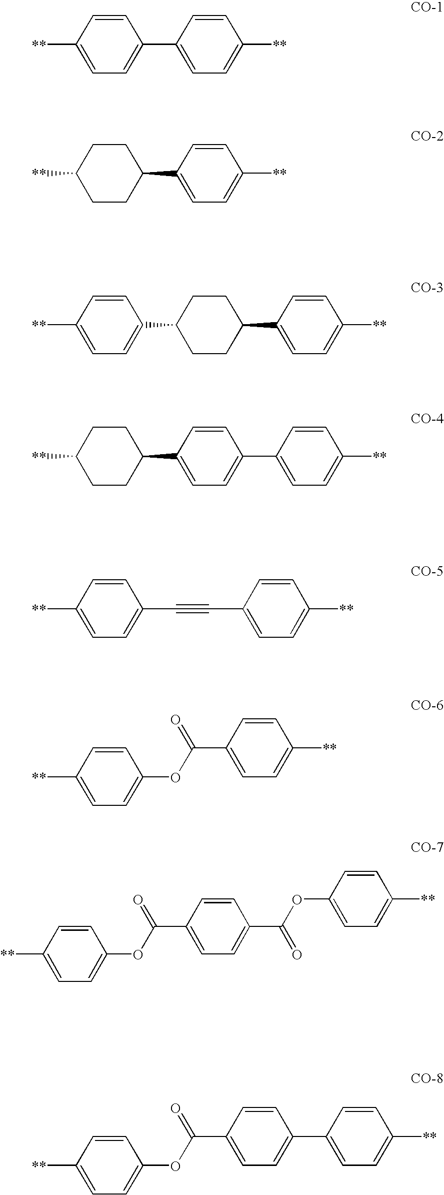

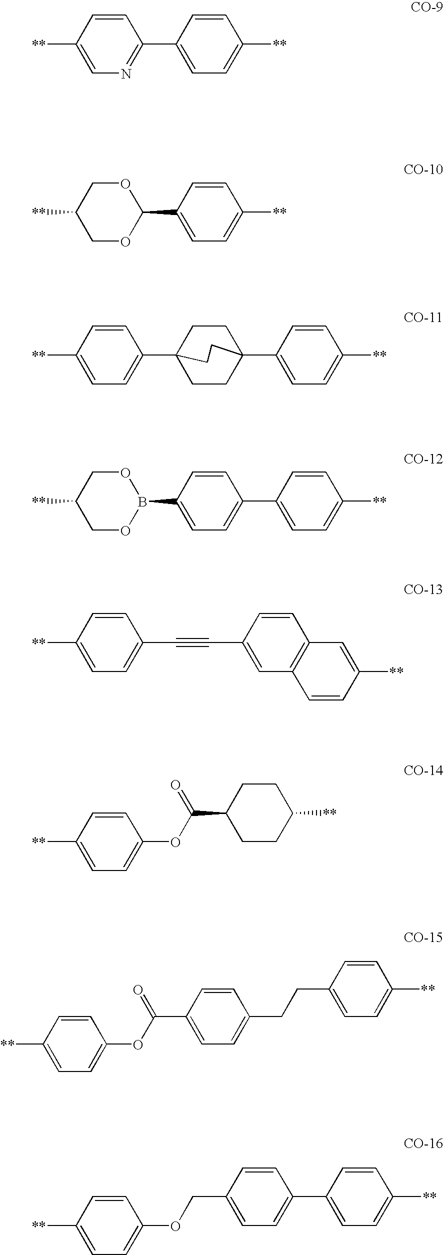

One of the cyclic groups constituting MG₁ and MG₂ are substituted with L₁ and L₂, which each independently represents a linkage group represented by following formula (I)-LA or (I)-LB respectively substituted on the liquid crystal cores MG₁ and MG₂.

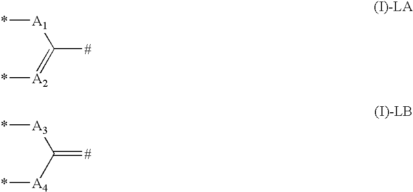

wherein:

* represents a substituting position on a cyclic group constituting MG₁ or MG₂;

# represents a connecting position to P; and

A₁, A₃ and A₄ each independently represents —O—, —NH—, —S—, —CH₂—, —CO—, —SO—, or —SO₂—.

In the case where A₁, A₃ or A₄ is —NH— or —CH₂—, the hydrogen atom therein may be substituted by another substituent. Examples of such substituent include a halogen atom, an alkyl group containing 1 to 10 carbon atoms, an acyl group containing 1 to 10 carbon atoms and a cyano group. A₁ is preferably —O—, —NH—, —S— or —CH₂—, and particularly preferably —O— or —CH₂—. A₃ and A₄ each is preferably —O—, —NH—, —S—, —CO—, —SO—, or —SO₂—, and particularly preferably —O—, —NH—, —S— or —CO—.

A₂ represents —CH═ or —N═.

In the case where A₂ is —CH═, the hydrogen atom therein may be substituted by another substituent. Examples of such substituent include a halogen atom, an alkyl group containing 1 to 10 carbon atoms, an acyl group containing 1 to 10 carbon atoms and a cyano group.

In the case where L₁ and L₂ in the formula (I) are groups represented by the formula (I)-LA, a substituent P represents a divalent linkage group selected from a group of —CH═CH—, —C≡C—, 1,4-phenylene and a combination thereof, or a single bond. The linkage group P has to be selected adequately, since certain combinations may provide an excessively long absorption wavelength, thus resulting in a yellow coloration. P is preferably a single bond, —CH═CH—, —CH═CH—CH═CH—, —CH═CH—C═C—, —C≡C—, —C≡C—C≡C— or 1,4-phenylene, and more preferably a single bond, —CH═CH—, —C≡C—, —C≡C—C≡C— or 1,4-phenylene. In a case where P includes —CH═CH— or 1,4-phenylene, a methine group therein may be replaced by a nitrogen atom. Also a hydrogen atom of —CH═CH— or 1,4-phenylene may be replaced by another substituent. Examples of such substituent include a halogen atom, an alkyl group containing 1 to 10 carbon atoms, an acyl group containing 1 to 10 carbon atoms and a cyano group.

In a case where either one of L₁ and L₂ is a group represented by the formula (I)-LB, P is represented by *═CH—P₁-# or *═N—P₁-# (wherein * indicates a connecting position with the group of formula (I)-LB and # indicates a connecting position with the group of formula (I)-LA). P₁ has to be selected adequately, since certain combinations may provide an excessively long absorption wavelength, thus resulting in a yellow coloration. P₁ is preferably a single bond, —CH═CH—, —CH═CH—CH═CH—, —CH═CH—C≡C—, —C≡C—, —C≡C—C≡C— or 1,4-phenylene, and more preferably a single bond, —CH═CH—, —C≡C—, —C≡C—C≡C— or 1,4-phenylene. In a case where P₁ includes —CH═CH— or 1,4-phenylene, a methine group therein may be replaced by a nitrogen atom. Also a hydrogen atom of —CH═CH— or 1,4-phenylene may be replaced by another substituent. Examples of such substituent include a halogen atom, an alkyl group containing 1 to 10 carbon atoms, an acyl group containing 1 to 10 carbon atoms and a cyano group.

In a case where L₁ and L₂ are groups represented by the formula (I)-LB, P represents a double bond, ═CH—P₁—CH═, ═N—P₁—CH═, or ═N—P₁—N═, in which P₁ has the same meaning as P₁ above.

In the following, examples of MG₁ and MG₂, substituted with L₁ and L₂, are shown (in which ** indicates a connecting position with R₁ (R₃) or R₂ (R₄), and # indicates a connecting position with P).

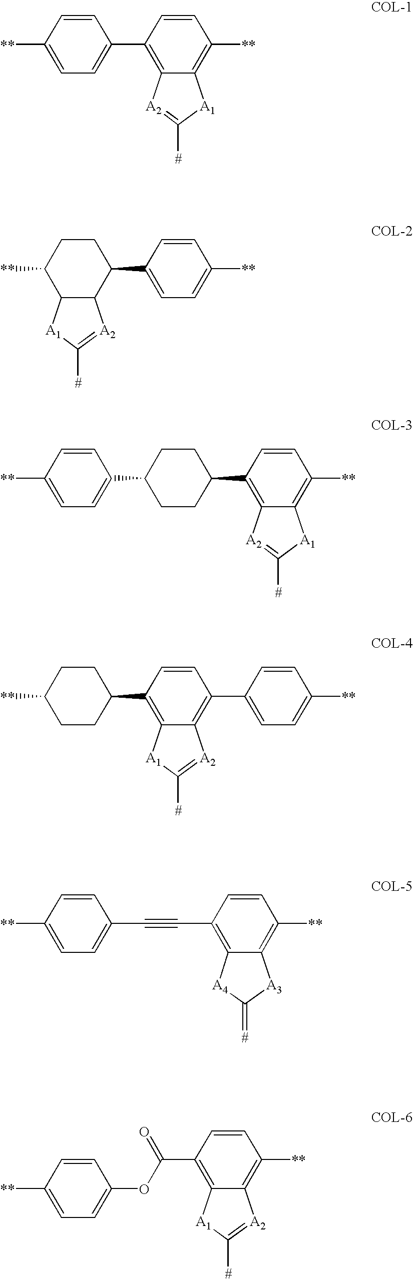

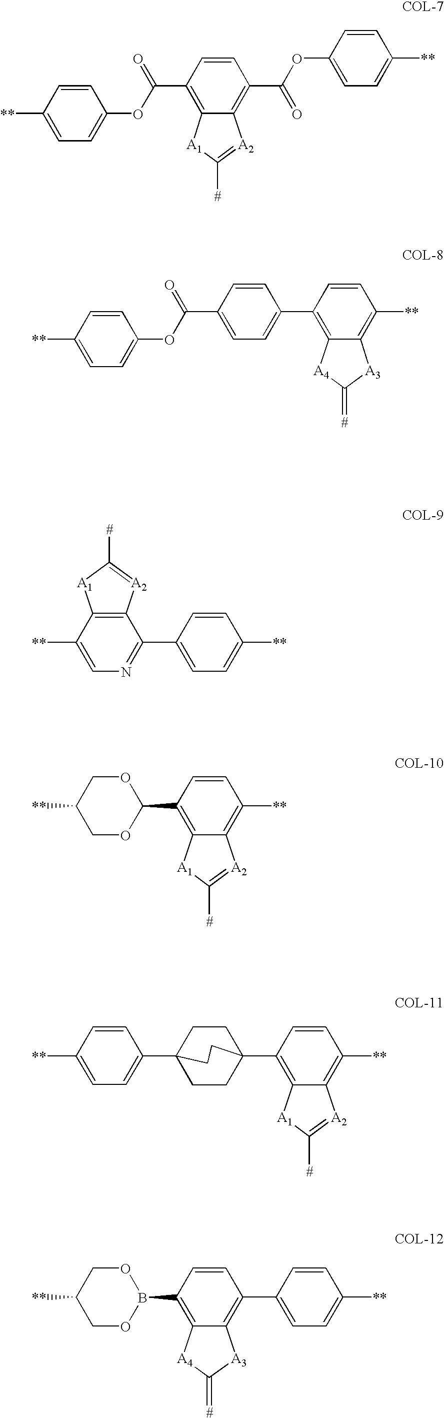

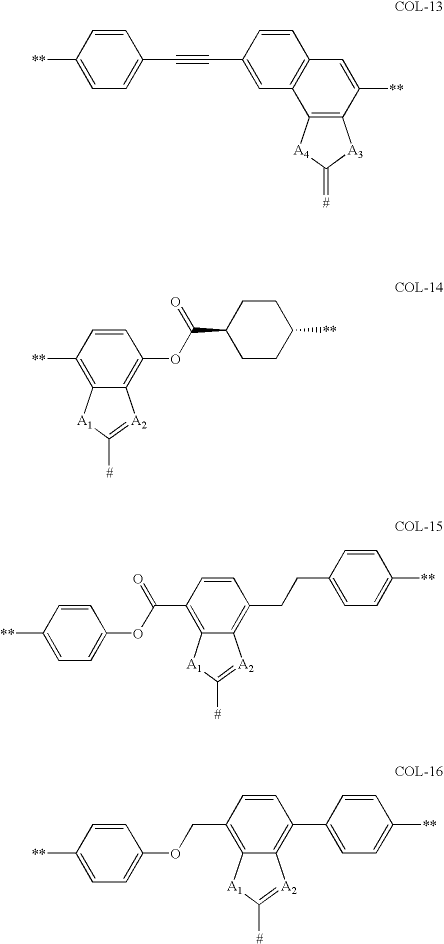

A cyclic group constituting MG₁ or MG₂ may include a substituent in addition to L₁ or L₂. Examples of such substituent include a halogen atom, a cyano group, a nitro group, an alkyl group containing 1 to 5 carbon atoms, a halogen-substituted alkyl group containing 1 to 5 carbon atoms, an alkoxy group containing 1 to 5 carbon atoms, an alkylthio group containing 1 to 5 carbon atoms, an acyloxy group containing 2 to 6 carbon atoms, an alkoxycarbonyl group containing 2 to 6 carbon atoms, a carbamoyl group, an alkyl-substituted carbamoyl group containing 2 to 6 carbon atoms, and an acylamino group containing 2 to 6 carbon atoms.

R₁, R₂, R₃ and R₄ each represents a flexible substituent group, a dipole function group or a hydrogen bonding group, substituted in a molecular longitudinal axial direction of the liquid crystal core and inducing expression of the liquid crystal phase.

Examples of the flexible substituent include an alkyl group containing 1 to 20 carbon atoms, an alkyloxy group containing 1 to 20 carbon atoms, an acyl group containing 2 to 20 carbon atoms, an alkoxycarbonyl group containing 2 to 20 carbon atoms, an acyloxy group containing 2 to 20 carbon atoms, an alkoxycarbonyloxy group containing 2 to 20 carbon atoms, an alkylthio group containing 1 to 20 carbon atoms, an amino group containing 1 to 20 carbon atoms, an acylamino group containing 2 to 20 carbon atoms, and an alkoxycarbonylamino group containing 2 to 20 carbon atoms. Such flexible substituent may be further substituted with another substituent. Examples of such substituent include an alkyl group (such as a methyl group, an ethyl group, an isopropyl group, or a tert-butyl group), an alkenyl group (such as a vinyl group, an allyl group, a 2-butenyl group or a 3-pentenyl group), an alkinyl group (such as a propalgyl group, or a 3-pentynyl group), an aryl group (such as a phenyl group, a p-methylphenyl group or a naphthyl group), a substituted or non-substituted amino group (such as a non-substituted amino group, a methylamino group, a dimethylamino group, a diethylamino group or an anilino group), an alkoxy group (such as a methoxy group, an ethoxy group, or a butoxy group), an aryloxy group (such as a phenyloxy group, or a 2-naphthyloxy group), an acyl group (such as an acetyl group, a benzoyl group, a formyl group or a pivaloyl group), an alkoxycarbonyl group (such as a methoxycarbonyl group or an ethoxycarbonyl group), an aryloxycarbonyl group (such as a phenyloxycarbonyl group), an acyloxy group (such as an acetoxy group or a benzoyloxy group), an acylamino group (such as an acetylamino group or a benzoylamino group), an alkoxycarbonylamino group (such as a methoxycarbonylamino group), an aryloxycarbonylamino group (such as a phenyloxycarbonylamino group), an alkylsulfonylamino group (such as a methanesulfonylamino group), an arylsulfonylamino group (such as a benzenesulfonylamino group), a sulfamoyl group (such as a sulfamoyl group, an N-methylsulfamoyl group, an N,N-dimethylsulfamoyl group or an N-phenylsulfamoyl group), a carbamoyl group (such as a non-substituted carbamoyl group, an N-methylcarbamoyl group, an N,N-diethylcarbamoyl group or an N-phenylcarbamoyl group), an alkylthio group (such as a methylthio group, or an ethylthio group), an arylthio group (such as a phenylthio group), an alkylsulfonyl group (such as a mesyl group), an arylsulfonyl group (such as a tosyl group), an alkylsulfinyl group (such as a methanesulfinyl group), an arylsulfinyl group (such as a benzenesulfinyl group), an ureido group (such as a non-substituted ureido group, a 3-methylureido group, or a 3-phenylureido group), a phosphoryl amide group (such as a diethylphosphoryl amide group or a phenylphosphoryl amide group), a hydroxyl group, a mercapto group, a halogen atom (such as a fluorine atom, a chlorine atom, a bromine atom, or an iodine atom), a cyano group, a sulfo group, a carboxyl group, a nitro group, a hydroxamic acid group, a sulfino group, a hydrazino group, an imino group, a heterocyclic group (for example a heterocyclic group containing a hetero atom such as a nitrogen atom, an oxygen atom or a sulfur atom; such as an imidazolyl group, a pyridyl group, a quinolyl group, a furyl group, a piperidyl group, a morpholino group, a benzoxazolyl group, a benzimidazolyl group, or a benzothiazolyl group), and a silyl group (such as a trimethylsilyl group or a triphenylsilyl group). Such substituent may be further substituted with these substituents.

Examples of the dipole function group include a halogen atom, a cyano group and a nitro group. Examples of the hydrogen bonding group include a carboxyl group and a hydroxyl group.

Even among the compounds represented by the formula (I), it is necessary, in order to realize the wavelength dispersion of Δn represented by the formula (1), to regulate (a) an absorption wavelength and an absorption intensity of the liquid crystal cores represented by MG₁ and MG₂, principally contributing to the extraordinary light, and (b) an absorption wavelength and an absorption intensity of a part, constituted of the cyclic-groups constituting MG₁ and MG₂ and -L₁-P-L₂- and achieving a longer wavelength in the absorption in the width direction, principally contributing to the ordinary light. In order to meet the relational formula (1), namely in order that the wavelength dispersion of the refractive index for the ordinary light is more inclined downwards toward right than that for the extraordinary light, it is essential that the absorption wavelength of (b) above is longer than that of (a) above. Also the absorption intensity is an important factor relating to the wavelength dispersion, but, as the refractive indexes for the ordinary light and the extraordinary light are defined by a balance of the absorption wavelength and the absorption intensity and also as it is difficult to actually measure the absorption wavelength and the absorption intensity for the ordinary light and the extraordinary light, it is extremely difficult to define these values. It is however empirically found that, in (a), an absorption wavelength at a highest absorption intensity is preferably 320 nm or less, and more preferably 300 nm or less, and, in (b), an absorption wavelength at a highest absorption intensity is preferably 280 nm or more and more preferably 300 nm or more. An excessively long absorption wavelength in (b) leads to a yellow coloration and is therefore undesirable. For this reason, an end portion of the absorption preferably does not exceed 400 nm. A difference in the absorption wavelengths at the highest absorption intensities in (a) and (b) is preferably 20 nm or larger, and more preferably 40 nm or larger. Also an absorption coefficient, at the absorption wavelength with the highest absorption intensity in (b), is preferably 0.1 times or larger of an absorption coefficient, at the absorption wavelength with the highest absorption intensity in (a), and more preferably 0.2 times or larger. However, the condition above may not be met in certain cases, since the absorption wavelength and the absorption intensity for (a) and (b) are not actually measurable in many instances and since subsidiary absorptions are present in many instances. A compound satisfying such conditions is preferably a compound represented by a following formula (II).

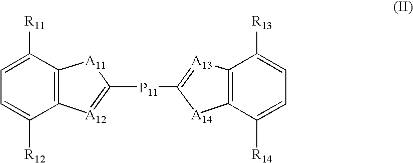

In the formula, A₁₁ and A₁₄ have the same meaning as A₁ in the formula (I); A₁₂ and A₁₃ have the same meaning as A₂ in the formula (I); and P₁₁ has the same meaning as P₁ in the formula (I).

In the formula (II), a hydrogen atom of a benzene ring condensed with a 5-membered ring may be substituted by another substituent. Examples of such substituent include a halogen atom, an alkyl group containing 1 to 10 carbon atoms, an acyl group containing 1 to 10 carbon atoms and a cyano group. Also in the formula (II), a methine group of the benzene ring condensed with the 5-membered ring may be replaced by a nitrogen atom.

R₁₁, R₁₂, R₁₃ and R₁₄ each independently is represented by formula (III):

*-L₁₁-Q (III)

wherein:

* indicates a bonding position to the benzene ring in the formula (II);

L₁₁ represents a divalent linkage group; and

Q represents a polymerizable group or a hydrogen atom.

In the case of utilizing the compound of the general formula (I) in an optical film of which a retardation is preferably not influenced by heat, such as an optical compensation film including the retardation plate of the invention, Q is preferably a polymerizable group. The polymerization reaction is preferably an addition polymerization (including a ring-opening polymerization) or a polycondensation. Stated differently, the polymerizable group is preferably capable of an addition polymerization reaction or a polycondensation reaction. Examples of the polymerizable group are shown below, but these examples are not to be construed as limiting the scope of the invention.

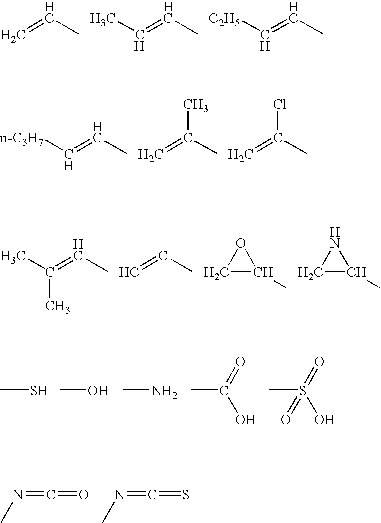

More preferably, the polymerizable group is a functional group capable of an addition polymerization reaction. Preferred examples of such polymerizable group include a polymerizable ethylenic unsaturated group and a ring-opening polymerizable group.

Examples of the polymerizable ethylenic unsaturated group include those of following formulas (M-1) to (M-6).

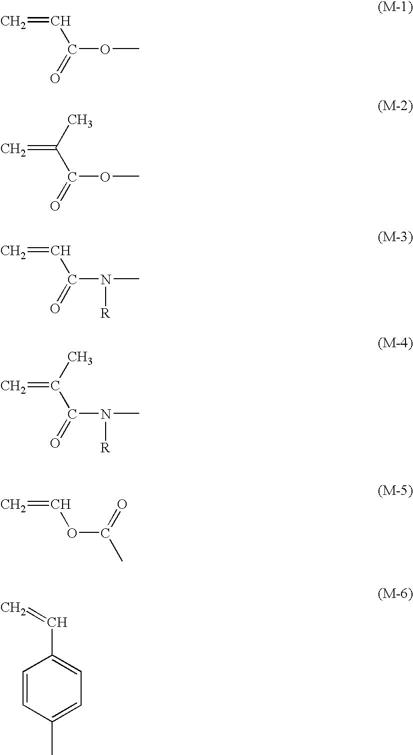

In the formulas (M-3) and (M-4), R represents a hydrogen atom or a substituent. Examples of the substituent include those recited above for R₁, R₂ and R₃. R is preferably a hydrogen atom or an alkyl group, and particularly preferably a hydrogen atom or a methyl group.

Among the structures (M-1) to (M-6), (M-1) or (M-2) is preferable, and (M-1) is most preferable.

The ring-opening polymerizable group is preferably a cyclic ether group, more preferably an epoxy group or an oxetanyl group, and most preferably an epoxy group.

In the formula (III), L₁₁ is preferably a divalent linkage group selected from a class of —O—, —S—, —C(═O)—, —NR₇—, a divalent linear group, a divalent cyclic group and a combination thereof. R₇ represents an alkyl group containing 1 to 7 carbon atoms or a hydrogen atom, preferably an alkyl group containing 1 to 4 carbon atoms or a hydrogen atom, more preferably a methyl group, an ethyl group or a hydrogen atom, and most preferably a hydrogen atom.

Examples of the divalent linear group represented by L₁₁ include an alkylene group, a substituted alkylene group, an alkenylene group, a substituted alkenylene group, an alkinylene group, and a substituted alkinylene group, among which an alkylene group, a substituted alkylene group, an alkenylene group or a substituted alkenylene group is preferable, and an alkylene group or an alkenylene group is more preferable.

The alkylene group, as the divalent linear group represented by L₁₁, may have a branched structure, and —CH₂— therein may be replaced for example by —O— or —S—. The alkylene group preferably contains 1 to 16 carbon atoms, more preferably 2 to 14 carbon atoms and most preferably 2 to 12 carbon atoms. In a substituted alkylene group, the alkylene portion may be same as the alkylene group defined above. Examples of the substituent include an alkyl group and a halogen atom.

An alkenylene group, as the divalent linear group represented by L₁₁, may contain a substituted or non-substituted alkylene group in a main chain thereof, and may have a branched structure. In the case where the alkenylene group includes —CH₂—, it may be replaced for example by —O— or —S—. The alkenylene group preferably contains 2 to 16 carbon atoms, more preferably 2 to 14 carbon atoms and most preferably 2 to 12 carbon atoms. In a substituted alkenylene group, the alkenylene portion may be same as the alkenylene group defined above. Examples of the substituent include an alkyl group and a halogen atom.

An alkinylene group, as the divalent linear group represented by L₁₁, may contain a substituted or non-substituted alkylene group in a main chain thereof, and may have a branched structure. In the case where the alkinylene group includes —CH₂—, it may be replaced for example by —O— or —S—. The alkinylene group preferably contains 2 to 16 carbon atoms, more preferably 2 to 14 carbon atoms and most preferably 2 to 12 carbon atoms. In a substituted alkinylene group, the alkinylene portion may be same as the alkinylene group defined above. Examples of the substituent include an alkyl group and a halogen atom.

Specific examples of the divalent linear group, represented by L₁₁, include ethylene, trimethylene, tetramethylene, 1-methyl-tetramethylene, pentamethylene, hexamethylene, octamethylene, nonamethylene, decamethylene, undecamethylene, dodecamethylene, 2-butenylene and 2-butenylene.

The divalent cyclic group represented by L₁₁ is a divalent linkage group including at least a cyclic structure. The divalent cyclic group is preferably a 5-, 6- or 7-membered ring, more preferably a 5-membered ring or a 6-membered ring, and most preferably a 6-membered ring. The ring contained in the cyclic group may be a condensed ring, but a single ring is preferable to a condensed ring. Also the ring contained in the cyclic group may be any one of an aromatic ring, an aliphatic ring and a heterocycle. Examples of the aromatic ring include a benzene ring and a naphthalene ring. Examples of the aliphatic ring include a cyclohexane ring. Examples of the heterocycle include a pyridine ring, a pyrimidine ring, a thiophene ring, a 1,3-dioxane ring and a 1,3-dithiane ring.

Among the divalent cyclic groups represented by L₁₁, a cyclic ring including a benzene ring is preferably 1,4-phenylene. A cyclic group including a naphthalene ring is preferably naphthalene-1,5-diyl or naphthalene-2,6-diyl. A cyclic group including a cyclohexane ring is preferably 1,4-cyclohexylene. A cyclic group including a pyridine ring is preferably pyridine-2,5-diyl. A cyclic group including a pyrimidine ring is preferably pyrimidine-2,5-diyl. A cyclic group including a thiophene ring is preferably thiophene-2,5-diyl. A cyclic group including a 1,3-dioxane ring is preferably 1,3-dioxylene-2,5-diyl. A cyclic group including a 1,3-dithiane ring is preferably 1,3-dithianylen-2,5-diyl.

The divalent cyclic group represented by L₁₁ may have a substituent. Examples of the substituent include a halogen atom, a cyano group, a nitro group, an alkyl group containing 1 to 16 carbon atoms, a halogen-substituted alkyl group containing 1 to 16 carbon atoms, an alkoxy group containing 1 to 16 carbon atoms, an acyl group containing 2 to 16 carbon atoms, an alkylthio group containing 1 to 16 carbon atoms, an acyloxy group containing 2 to 16 carbon atoms, an alkoxycarbonyl group containing 2 to 16 carbon atoms, a carbamoyl group, an alkyl-substituted carbamoyl group containing 2 to 16 carbon atoms, and an acylamino group containing 2 to 16 carbon atoms.

Examples the divalent linkage group represented by L₁₁ are shown below, in which the right-hand side is bonded to the benzene ring in the formula (II) and the left-hand side is bonded to Q.

L-1: -divalent linear group-O-divalent cyclic group-
L-2: -divalent linear group-O-divalent cyclic group-CO—O—
L-3: -divalent linear group-O-divalent cyclic group-O—CO—
L-4: -divalent linear group-O-divalent cyclic group-CO—NR₇—
L-5: -divalent linear group-O-divalent cyclic group-divalent linear group-
L-6: -divalent linear group-O-divalent cyclic group-divalent linear group-CO—O—
L-7: -divalent linear group-O-divalent cyclic group-divalent linear group-O—CO—
L-8: -divalent linear group-O—CO-divalent cyclic group-
L-9: -divalent linear group-O—CO-divalent cyclic group-CO—O—
L-10: -divalent linear group-O—CO-divalent cyclic group-O—CO—
L-11: -divalent linear group-O—CO-divalent cyclic group-CO—NR₇—
L-12: -divalent linear group-O—CO-divalent cyclic group-divalent linear group-
L-13: -divalent linear group-O—CO-divalent cyclic group-divalent linear group-CO—O—
L-14: -divalent linear group-O—CO-divalent cyclic group-divalent linear group-O—CO—
L-15: -divalent linear group-CO—O-divalent cyclic group-
L-16: -divalent linear group-CO—O-divalent cyclic group-CO—O—
L-17: -divalent linear group-CO—O-divalent cyclic group-O—CO—
L-18: -divalent linear group-CO—O-divalent cyclic group-CO—NR₇—
L-19: -divalent linear group-CO—O-divalent cyclic group-divalent linear group-
L-20: -divalent linear group-CO—O-divalent cyclic group-divalent linear group-CO—O—
L-21: -divalent linear group-CO—O-divalent cyclic group-divalent linear group-O—CO—
L-22: -divalent linear group-O—CO—O-divalent cyclic group-
L-23: -divalent linear group-O—CO—O-divalent cyclic group-CO—O—
L-24: -divalent linear group-O—CO—O-divalent cyclic group-O—CO—
L-25: -divalent linear group-O—CO—O-divalent cyclic group-CO—NR₇—
L-26: -divalent linear group-O—CO—O-divalent cyclic group-divalent linear group-
L-27: -divalent linear group-O—CO—O-divalent cyclic group-divalent linear group-CO—O—
L-28: -divalent linear group-O—CO—O-divalent cyclic group-divalent linear group-O—CO—
L-29: -divalent linear group-
L-30: -divalent linear group-O—
L-31: -divalent linear group-CO—O—
L-32: -divalent linear group-O—CO—
L-33: -divalent linear group-CO—NR₇—
L-34: -divalent linear group-O-divalent linear group-
L-35: -divalent linear group-O-divalent linear group-O—
L-36: -divalent linear group-O-divalent linear group-CO—O—
L-37: -divalent linear group-O-divalent linear group-O—CO—

R₁₁, R₁₂, R₁₃ and R₁₄ each independently is preferably represented by following formula (IV):

*-L₂₁-divalent cyclic group-L₂₂-divalent linear group-Q₂₁ (IV)

In the formula (IV), * indicates a bonding position to the benzene ring in the formula (II), and L₂₁ represents a single bond or a divalent linkage group. In the case that L₂₁ is a divalent linkage group, it is preferably a divalent linkage group selected from a class of —O—, —S—, —C(═O)—, —NR₇—, —CH₂—, —CH═CH—, —C≡C— and a combination thereof. R₇ represents an alkyl group containing 1 to 7 carbon atoms or a hydrogen atom, preferably an alkyl group containing 1 to 4 carbon atoms or a hydrogen atom, more preferably a methyl group, an ethyl group or a hydrogen atom, and most preferably a hydrogen atom.

L₂₁ is preferably a single bond, *—O—CO—, *—CO—O—, *—CH₂—CH₂—, *—O—CH₂—, *—CH₂—O—, or *—CO—CH₂—CH₂— (wherein * indicates the side of * in the formula (IV)), and particularly preferably a single bond, *—O—CO— or *—CO—O—.

In the formula (IV), the divalent cyclic group has the same definition as the divalent cyclic group in the formula (III).

In the formula (IV), the divalent cyclic group is preferably 1,4-phenylene, 1,4-cyclohexylene, pyridine-2,5-diyl, pyrimidine-2,5-diyl or 1,3-dioxylene-2,5-diyl, and particularly preferably 1,4-phenylene, 1,4-cyclohexylene, or 1,3-dioxylene-2,5-diyl.

The divalent cyclic group in the formula (IV) may have a substituent, and preferred examples of the substituent include a halogen atom (such as a fluorine atom, a chlorine atom, a bromine atom or an iodine atom), an alkyl group containing 1 to 8 carbon atoms, an alkyloxy group containing 1 to 8 carbon atoms, an acyl group containing 2 to 8 carbon atoms, an acyloxy group containing 2 to 8 carbon atoms, an alkoxycarbonyl group containing 2 to 8 carbon atoms, a nitro group, and a cyano group, among which a halogen atom, an alkyl group containing 1 to 3 carbon atoms, an alkyloxy group containing 1 to 3 carbon atoms, an acyl group containing 2 to 4 carbon atoms, an acyloxy group containing 2 to 4 carbon atoms, an alkoxycarbonyl group containing 2 to 4 carbon atoms, or a cyano group is particularly preferable.

L₂₂ represents a single bond or a divalent linkage group. In the case that L₂₂ is a divalent linkage group, it is preferably a divalent linkage group selected from a class of —O—, —S—, —C(═O)—, —NR₇— and a combination thereof. R₇ represents an alkyl group containing 1 to 7 carbon atoms or a hydrogen atom, preferably an alkyl group containing 1 to 4 carbon atoms or a hydrogen atom, more preferably a methyl group, an ethyl group or a hydrogen atom, and most preferably a hydrogen atom.

L₂₂ is preferably a single bond, *—O—, *—O—CO—, *—CO—O—, *—O—CO—O—, *—CO—, *—S— or *—NR₇— (wherein * indicates a bonding position to the divalent cyclic group in the formula (V)), and particularly preferably a single bond, *—O—, *—O—CO—, *—CO—O— or *—O—CO—O—.

In the formula (IV), the divalent linear group has the same definition as the divalent linear group in the formula (III).

In the formula (IV), the divalent linear group is preferably a substituted or non-substituted alkylene group containing 1 to 16 carbon atoms, a substituted or non-substituted alkenylene group containing 2 to 16 carbon atoms, or a substituted or non-substituted alkinylene group containing 2 to 16 carbon atoms, and particularly preferably a substituted or non-substituted alkylene group containing 1 to 12 carbon atoms. A substituent on the linear group is preferably an alkyl group containing 1 to 5 carbon atoms or a halogen atom. The divalent linear group is most preferably a non-substituted alkylene group containing 1 to 12 carbon atoms.

Q₂₁ in the formula (IV) represents a polymerizable group or a hydrogen atom. The polymerizable group is preferably —O—CO—C(R₆)═CH₂, in which R₆ represent a hydrogen atom or a methyl group, preferably a hydrogen atom.

In the invention, among the compounds represented by the formula (I), there is preferred a compound represented by the formula (II) above, in which R₁₁, R₁₂, R₁₃ and R₁₄ each independently is represented by the formula (IV) above.

Specific examples of the compound represented by the formula (I) or (II) are shown below, but these examples are not to be construed as limiting the scope of the invention.

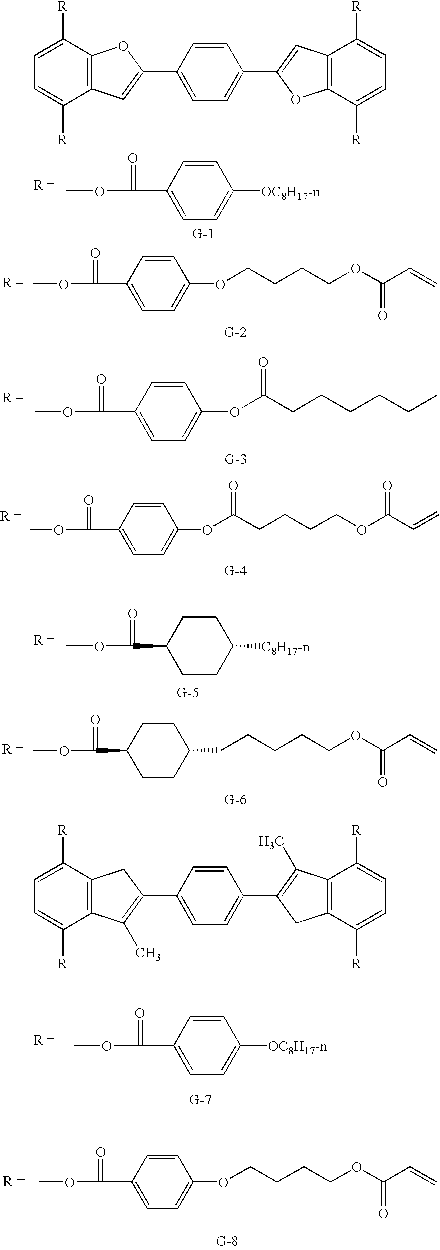

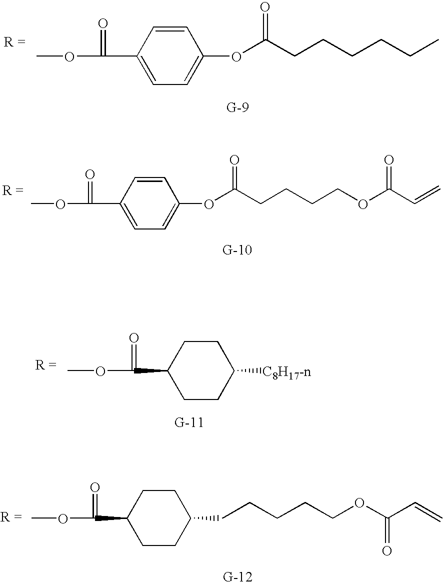

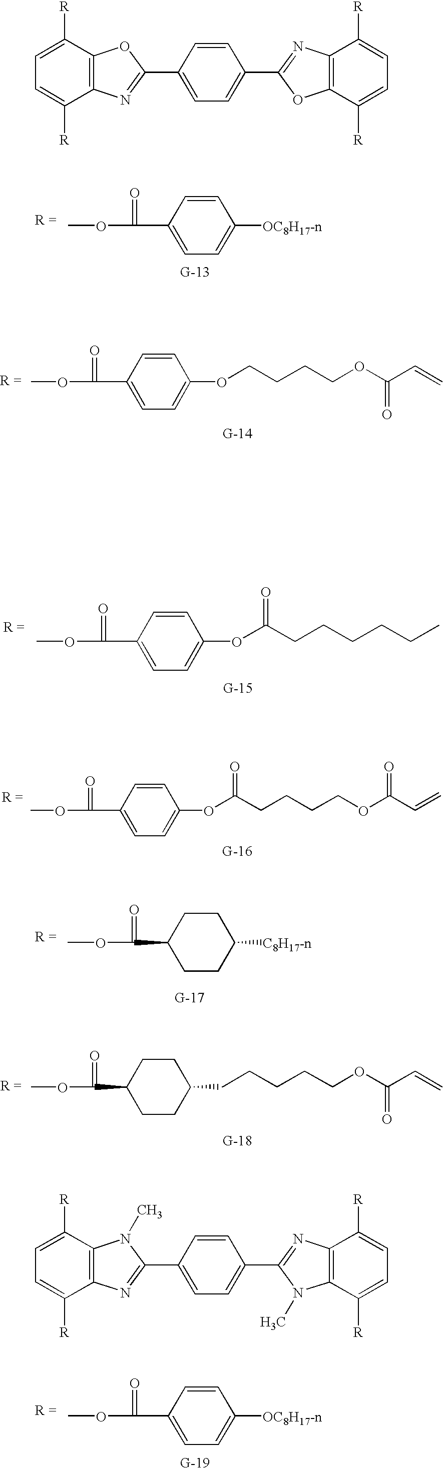

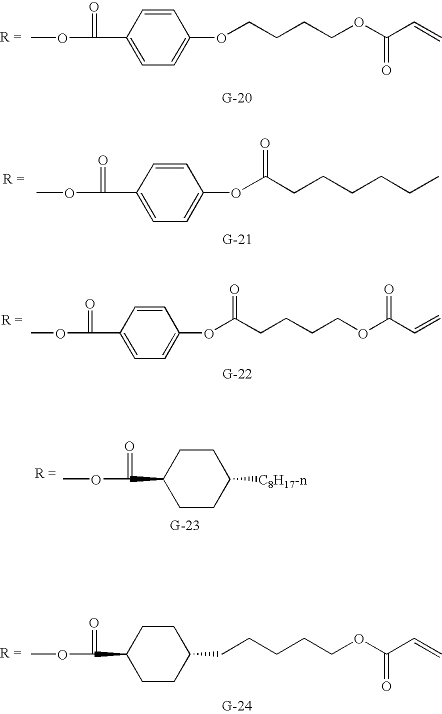

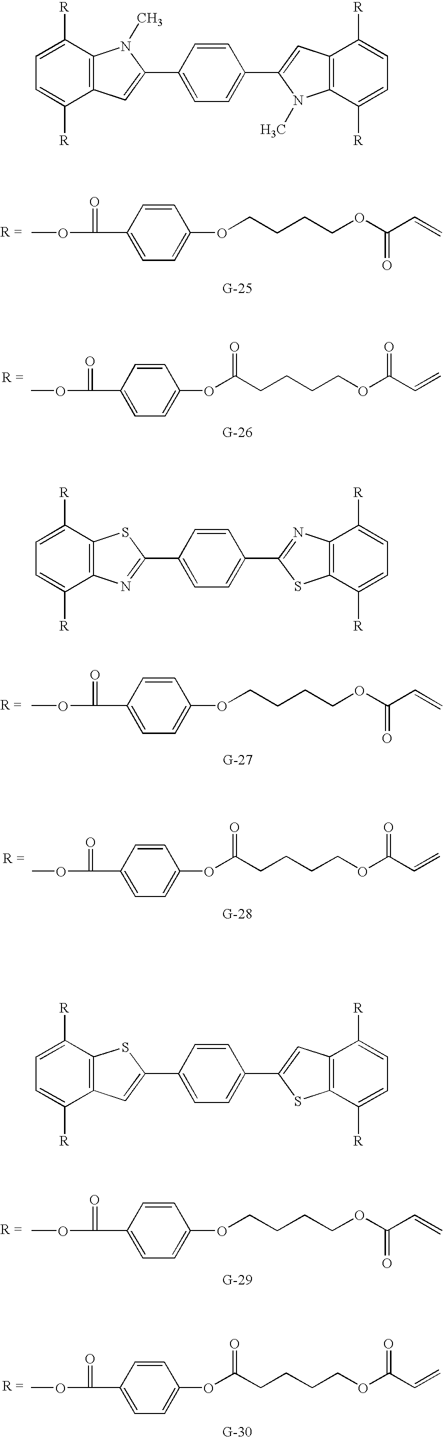

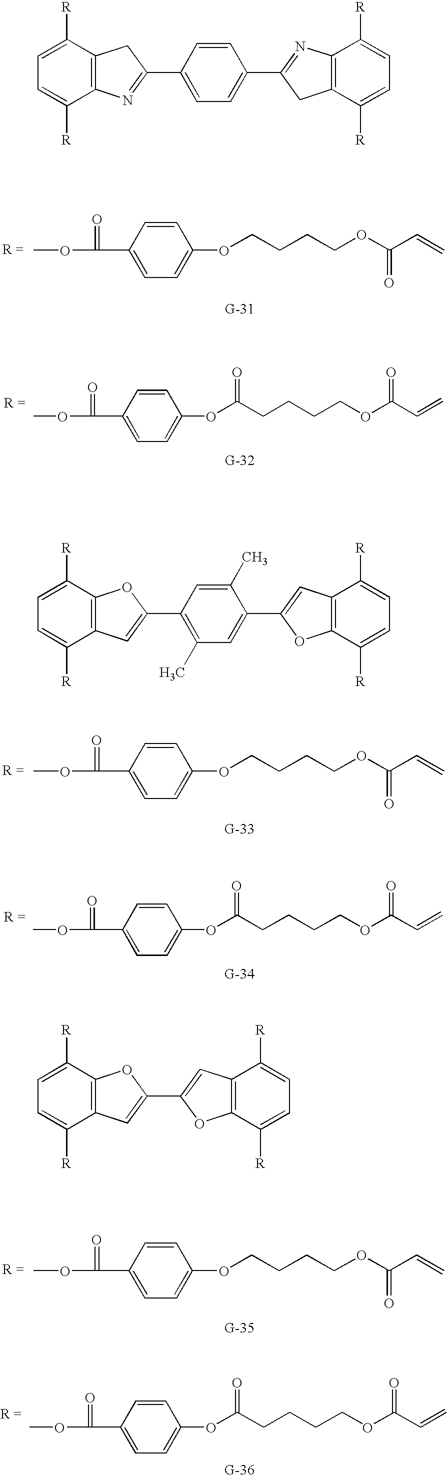

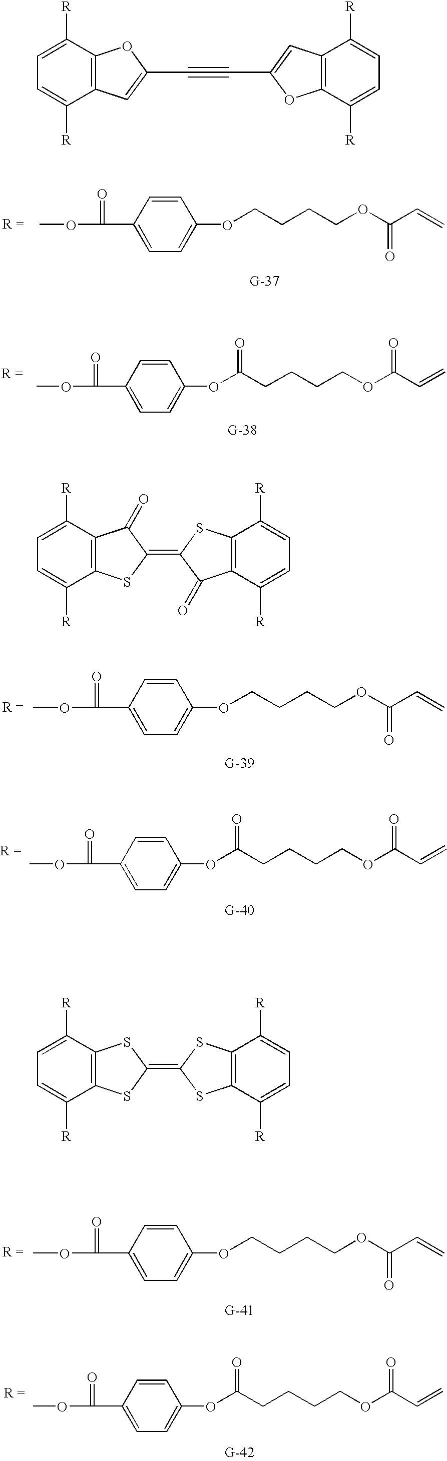

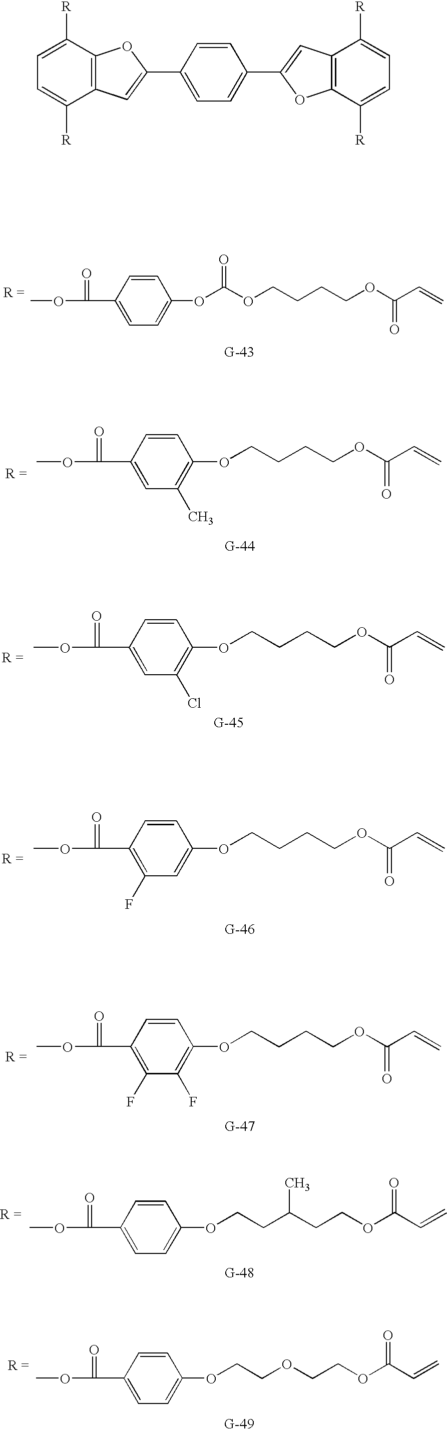

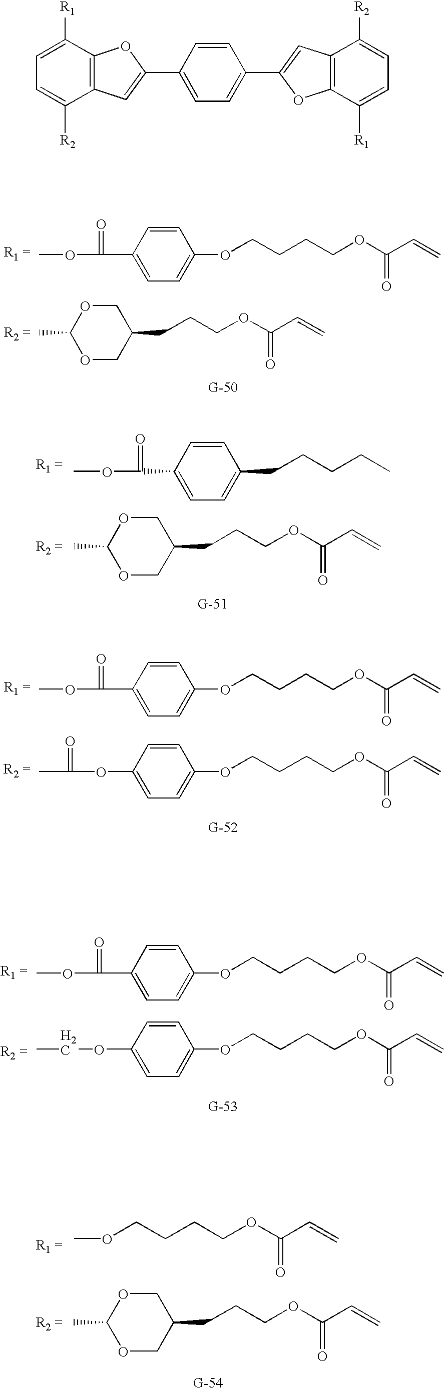

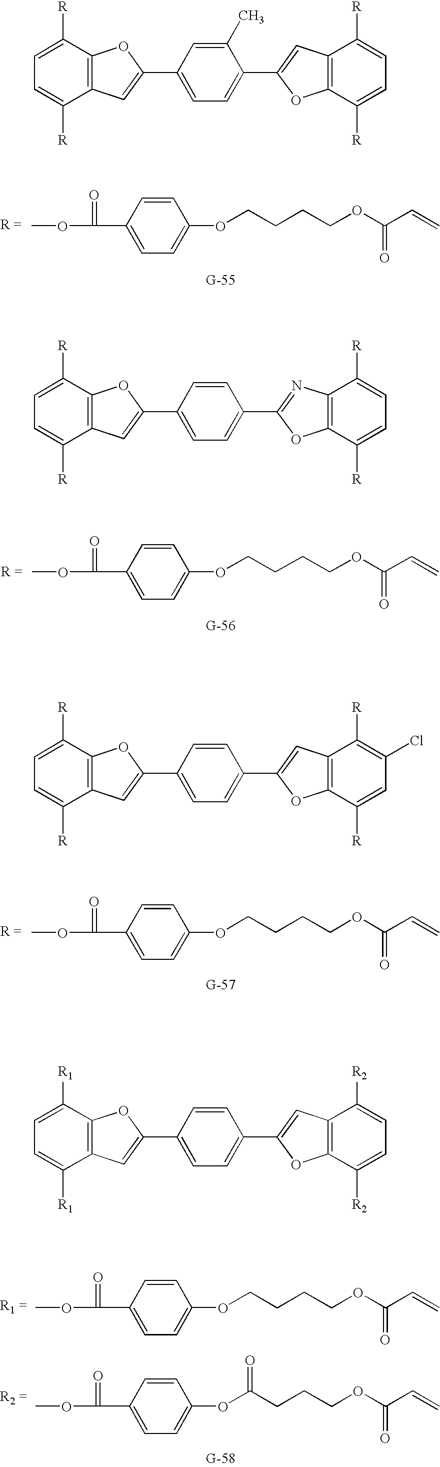

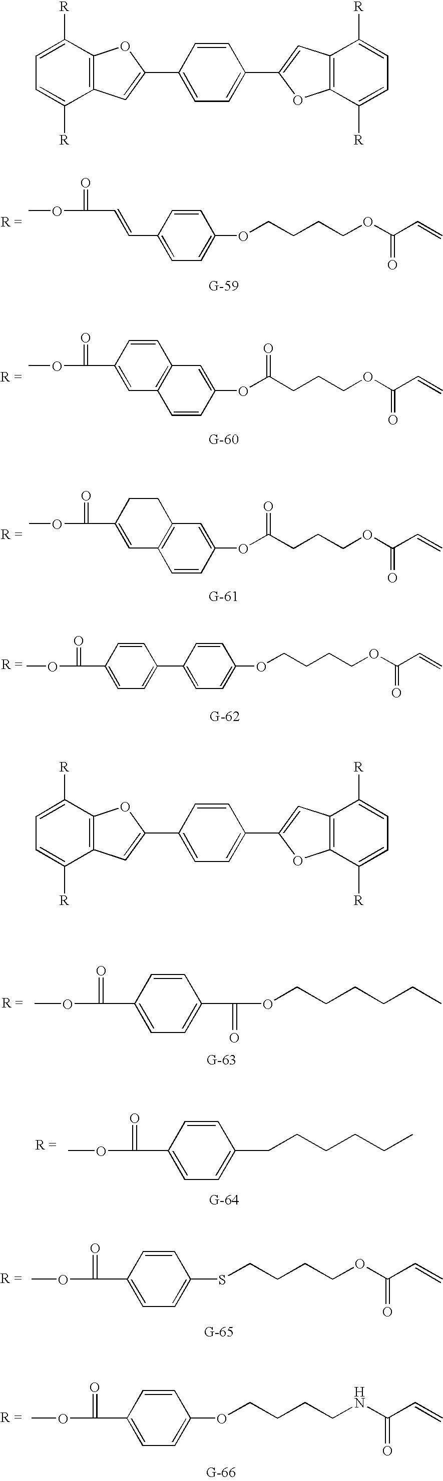

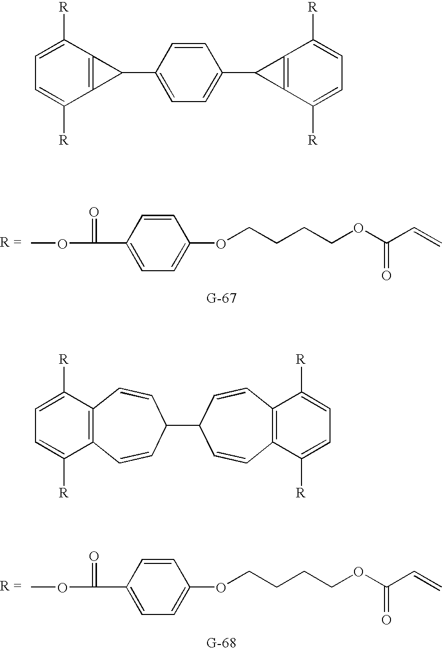

A liquid crystal compound of the invention shows scarce change of the wavelength dispersion by temperature, as long as it remains in a same liquid crystal phase, but, in order to specify the invention more clearly, a measuring temperature for the following formula (1) is defined as 20° C. below an upper limit of the phase-changing temperature. In a case where the liquid crystal phase has a temperature range of 20° C. or less, the measurement is to be made at 10° C. below the upper limit temperature of the liquid crystal phase, also in a case where the liquid crystal phase has a temperature range of 10° C. or less, the measurement is to be made at 5° C. below the upper limit temperature, and, in a case where the liquid crystal phase has a temperature range of 5° C. or less, the measurement is to be made at 2° C. below the upper limit temperature:

Δn(450 nm)/Δn(550 nm)<1.0 (1)

A range of the wavelength dispersion of Δn cannot be uniquely defined since a preferable range is variable depending on the application of the liquid crystal compound, but, for a more preferable range, the wavelength dispersion of Δn preferably satisfies following relations (1)-1 and (1)-2:

0.60<Δn(450 nm)/Δn(550 nm)<0.99 (1)-1

1.01<Δn(650 nm)/Δn(550 nm)<1.35 (1)-2

wherein Δn(450), Δn(550) and Δn(650) indicate Δn respectively at 450, 550 and 650 nm. However, each measuring wavelength is assumed to include an error of ±10 nm.

A liquid crystal compound of the invention may have a positive or negative birefringence, but preferably has a positive birefringence.

Liquid crystal phases showing a positive birefringence are described, in detail for example in Ekishou Binran (Liquid crystal handbook), Chapter 2 (published by Maruzen, 2000), and include for example a nematic phase, a cholesteric phase, and a smectic phase (such as a smectic-A phase and a smectic-C phase).

In the case of utilizing a liquid crystal compound of the invention in an optically anisotropic layer, a compound showing a satisfactory monodomain property is desirable in order to realize a uniform defect-free alignment. An insufficient monodomain property leads to a polydomain structure involving an alignment defect in the domain boundary, resulting in a light scattering. This leads to a loss in the transmittance of the optically anisotropic layer and is therefore undesirable. For realizing a satisfactory monodomain property, the liquid crystal compound of the invention preferably expresses a nematic phase (N-phase) or a smecric-A phase (S_{A}-phase), and particularly preferably expresses a nematic phase.

An addition of a chiral agent to such liquid crystal phase allow to express a TGB chiral smectic-A phase, a chiral smectic-C phase, a blue phase or a chiral nematic phase. Among such chiral agent-containing liquid crystal phases, a chiral nematic phase is particularly preferable.

The liquid crystal compound may be a low-molecular liquid crystal compound or a high-molecular liquid crystal compound, but a low-molecular liquid crystal compound is preferable in consideration of ease of alignment.

The liquid crystal compound preferably includes a polymerizable group, and more preferably includes a polymerizable group at a terminal end of the molecule of the liquid crystal compound. Presence of such polymerizable group allows to advantageously avoid a change in the retardation, for example by heat, in the case of use in a retardation plate or the like.

Δn of liquid crystal may be measured by a method of utilizing a wedge-shaped liquid crystal cell, as described for example in Ekishou Binran (Liquid crystal handbook), 2.4.13 (published by Maruzen, 2000). This method utilizes three band-pass filters of 450, 550 and 650 nm to measure Δn at the respective wavelengths. When the liquid crystal compound includes a polymerizable group, a polymerization reaction may take place in the wedge-shaped liquid crystal cell, thereby often hindering the measurement. In such case, the measurement is preferably conducted with an addition of a polymerization inhibitor. It is also possible to utilize a retardation-measuring apparatus such as KOBRA (manufactured by Oji Keisoku Kiki Co.) on the liquid crystal in a uniformly aligned state to determine Re at the respective wavelengths, and to determine Δn by separately measuring the film thickness (based on a relation: Δn=Re/d (film thickness)).

A liquid crystal compound of the invention may be employed singly or in a combination of plural kinds. For example, a polymerizable liquid crystal compound and a non-polymerizable liquid crystal compound may be used in combination. Also a low-molecular liquid crystal compound and a high-molecular liquid crystal compound may be used in combination. Also two liquid crystal compounds satisfying the formula (1) may be mixed.

The compound represented by the formula (II) of the invention need not necessarily have a liquid crystalline property. In case it does not show a liquid crystalline property, a liquid crystalline composition may be obtained by mixing with a liquid crystal compound of the invention showing a liquid crystalline property, or by mixing with a liquid crystal compound which is not included in the scope of the invention.

The liquid crystal compound satisfying the formula (I) of the invention may be mixed with a liquid crystal compound, in which the wavelength dispersion of Δn is a normal dispersion. A normal wavelength dispersion means satisfying the following formula (1-a):

Δn(450 nm)/Δn(550 nm)>1.0 (1-a)

Mixing of the liquid crystal compound of the invention, satisfying the relational formula (1), and a liquid crystal compound having a normal wavelength dispersion of Δn allows to obtain a liquid crystal composition having an intermediate wavelength dispersion property. More specifically, a region represented by the following formula (1-b) has been very difficult to realize with the hitherto known liquid crystal compounds. However, a liquid crystal composition having a wavelength dispersion in the region represented by the relational formula (1-b) can be easily prepared by mixing the liquid crystal compound of the invention, satisfying the formula (1), and a liquid crystal compound having a normal wavelength dispersion for Δn:

1.0<Δn(450 nm)/Δn(550 nm)<1.1 (1-b)

A liquid crystal compound of the invention, satisfying the formula (1), shows a liquid crystalline property and may probably be mixed, at an arbitrary mixing ratio, with the liquid crystal compound having a normal wavelength dispersion for Δn. Therefore, the mixing ratio may be changed according to a desired wavelength dispersion property.

In the case of utilizing a liquid crystal composition of the invention in a retardation plate, in consideration for example of manufacturability, a temperature range of the liquid crystal is preferably present within a range of from 10 to 250° C., and more preferably within a range of from 10 to 150° C. A temperature lower than 10° C. may require a cooling process or the like in order to reduce the temperature to the temperature range expressing the liquid crystal phase. Also a temperature exceeding 200° C. will require a high temperature in order to attain an isotropic liquid state at an even higher temperature than the temperature range expressing the liquid crystal phase, and is disadvantageous in energy wasting and in deformation or deterioration of the substrate.

In a liquid crystal composition of the invention, arbitrary additives may be used in addition to the chiral agent and the liquid crystal compound. Examples of the additives include a liquid crystal compound not included in the scope of the present invention, and an alignment control agent at an air interface, an antirepellent agent, a polymerization initiator, and a polymerizable monomer to be explained below.

(Alignment Control Agent at Air Interface)

Liquid crystal compounds are known to show a different tilt angle (inclination angle) at an air interface, depending on the type of the compound. Such tilt angle at the air interface has to be arbitrarily controlled according to the optical purpose of the retardation plate. The tilt angle may be controlled by an external field such as an electric field or a magnetic field or by an additive, but is preferably controlled by an additive. A preferable additive for this purpose is a compound having a substituted or non-substituted aliphatic group containing 6 to 40 carbon atoms or an oligosiloxanoxy group substituted with a substituted or non-substituted aliphatic group containing 6 to 40 carbon atoms, by at least one unit within the molecule, and a compound having such group by two or more units within the molecule is more preferable.

The additive for controlling the alignment at the air interface is preferably added in an amount of from 0.001 to 20 wt % with respect to the liquid crystal composition, more preferably from 0.01 to 10 wt % and most preferably from 0.1 to 5 wt %.

(Antirepellent Agent)

As a material to be employed with the liquid crystal compound, for the purpose of preventing repellency at the coating of the liquid crystal composition, generally a polymer may be employed advantageously. The polymer to be employed is not particularly restricted, as long as it does not significantly affect the inclination angle nor hinder the alignment of the liquid crystal compound. Examples of the polymer are described in JP-A-8-95030, and particularly preferable examples of the polymer include cellulose esters. Examples of such cellulose esters include cellulose acetate, cellulose acetate propionate, hydroxypropylcellulose and cellulose acetate butyrate. In order not to hinder the alignment of the liquid crystal, the polymer employed for the antirepellent purpose is preferably within a range of from 0.1 to 10 wt % with respect to the liquid crystal compound, more preferably from 0.1 to 8 wt % and further preferably from 0.1 to 5 wt %.

(Polymerization Initiator)

In the present invention, a liquid crystal compound is preferably fixed in a monodomain alignment, namely in a state of a substantially uniform alignment, and, in the case of utilizing a polymerizable liquid crystal compound, such as a compound having a polymerizable group in Q in the formula (II), it is preferable to fix the liquid crystal compound by a polymerization reaction.

The polymerization reaction includes a thermal polymerization reaction utilizing a thermal polymerization initiator, a photopolymerization reaction utilizing a photopolymerization initiator, and a polymerization reaction utilizing an electron beam irradiation, and a photopolymerization reaction and a polymerization reaction utilizing an electron beam irradiation are preferable in order to avoid a deformation or a deterioration of the substrate by heat. Examples of the photopolymerization initiator include an α-carbonyl compound (described in U.S. Pat. Nos. 2,367,661 and 2,367,670), an acyloin ether (described in U.S. Pat. No. 2,448,828), an α-hydrocarbon-substituted aromatic acyloin compound (described in U.S. Pat. No. 2,722,512), a polynucleic quinone compound (described in U.S. Pat. Nos. 3,046,127 and 2,951,758), a combination of a triarylimidazole dimer and p-aminophenyl ketone (described in U.S. Pat. No. 3,549,367), an acridine or phenazine compound (described in JP-A-60-105667 and U.S. Pat. No. 4,239,850), and an oxadiazole compound (described in U.S. Pat. No. 4,212,970). The photopolymerization initiator is preferably used in an amount of from 0.01 to 20 wt % with respect to the solids in the coating liquid, more preferably from 0.5 to 5 wt %. A light irradiation for polymerizing the liquid crystal compound, an ultraviolet light is preferably employed. An irradiation energy is preferably from 10 mJ/cm² to 50 J/cm², and more preferably from 50 to 800 mJ/cm². In order to accelerate the photopolymerization reaction, the light irradiation may be executed under a heated condition. Also a polymerization degree is influenced by an oxygen concentration in the atmosphere, it is preferable to reduce the oxygen concentration for example by a nitrogen replacement, in case a desired polymerization degree cannot be attained in the air. The oxygen concentration is preferably 10% or less, more preferably 7% or less, and most preferably 3% or less.

(Polymerizable Monomer)

A polymerizable monomer may be added to the liquid crystal composition. The polymerizable monomer to be used in combination with the liquid crystal compound is not particularly restricted as long as it is mutually soluble with the liquid crystal compound and it does not significantly affect the inclination angle nor hinder the alignment of the liquid crystal compound. Among such monomers, a compound having a polymerizable ethylenic unsaturated group, such as a vinyl group, a vinyloxy group, an acryloyl group or a methacryloyl group, is utilized preferably. The polymerizable monomer is generally added in an amount within a range of from 0.5 to 50 wt % with respect to the liquid crystal compound, and preferably within a range of from 1 to 30 wt %. Also a monomer including two or more reactive functional groups is particularly preferable, as an effect of improving the adhesion between an alignment film and an optically anisotropic layer may be expected.

(Coating Solvent)

As a solvent to be employed for preparing the liquid crystal composition, an organic solvent is employed preferably. Examples of the organic solvent include an amide (such as N,N-dimethylformamide), a sulfoxide (such as dimethylsulfoxide), a heterocyclic compound (such as pyridine), a hydrocarbon (such as toluene, or hexane), an alkyl halide (such as chloroform or dichloromethane), an ester (such as methyl acetate or butyl acetate), a ketone (such as acetone, methyl ethyl ketone, methyl isobutyl ketone or cyclohexanone), and an ether (such as tetrahydrofuran, or 1,2-dimethoxyethane). Among these, alkyl halides, esters and ketones are preferable. Also organic solvents of two or more kinds may be used in combination.

(Coating Method)

An optically anisotropic layer is formed by preparing, with a solvent described above, a coating liquid of the liquid crystal composition, and coating the coating liquid on an alignment film thereby aligning the liquid crystal compound. The coating liquid may be coated by a known method, such as a wired bar coating, an extrusion coating, a direct gravure coating, a reverse gravure coating or a die coating.

(Alignment Film)

An alignment film can be provided by a rubbing process of an organic compound (preferably a polymer), an inclined evaporation of an inorganic compound, a formation of a layer having microgrooves, or a deposition, by Langmuir-Bloggette (LB) method, of an organic compound (such as co-tricosanic acid or methyl stearate). There is also known an alignment film capable of exhibiting an aligning ability by an electrical field, a magnetic field or a light irradiation. Any layer capable of providing the liquid crystal compound, in an optically anisotropic layer provided thereon, with a desired alignment may be utilized as an alignment film, but, in the present invention, an alignment film formed by a rubbing process of a polymer or a light irradiation is preferable, and an alignment film formed by a rubbing process is particularly preferable. The rubbing process is generally executed by rubbing a surface of a polymer layer with a paper or a cloth several times in a fixed direction, but, in the invention, it is preferably executed by a method described in Ekishou Binran (Liquid crystal handbook), (published by Maruzen, 2000). The alignment film preferably has a thickness within a range of from 0.01 to 10 μm, and more preferably from 0.05 to 3 μm.

Polymers to be used as the alignment film are described in various references, and are available in various commercial products. Polyvinyl alcohol and derivatives thereof are preferably utilized in the alignment film for the retardation plate of the invention, and denatured polyvinyl alcohol, including a hydrophobic group, is particularly preferable. Also an alignment film utilized for discotic liquid crystal may be employed as the alignment film for liquid crystal. For such alignment film, reference may be made to the description in WO01/88574A1, page 43, line 24 to page 49, line 8.

(Rubbing Density of Alignment Film)

A rubbing density of the alignment film and a tilt angle of the liquid crystal compound at an interface of the alignment film are correlated in such a manner that a higher or lower rubbing density respectively provides a smaller or larger tilt angle. It is therefore possible to regulate the tilt angle by varying the rubbing density of the alignment film. For varying the rubbing density of the alignment film, a method described in Ekishou Binran (Liquid crystal handbook), (published by Maruzen, 2000) may be utilized. More specifically, a rubbing density (L) is quantitatively defined by the following equation (A):

L=Nl{1+((2πrn)/(60v))} Equation (A)

wherein N: a number of rubbings, l: a contact length of a rubbing roller, r: a radius of the rubbing roller, n: roller revolution (rpm), and v: stage moving speed (per second).

According to the equation (A), a higher rubbing density may be attained by increasing the number of rubbings, increasing the contact length of the rubbing roller, increasing the radius of the roller, increasing the revolution of the roller and/or decreasing the stage moving speed, and vice versa for a lower rubbing density.

(Transparent Substrate)

As a transparent substrate for a retardation plate of the invention, any material that is optically isotropic and has an optical transmission of 80% or higher may be employed without restriction, but a polymer film is preferable. Specific examples of the polymer include a cellulose ester (such as cellulose diacetate, or cellulose triacetate), a norbornene-type polymer, and a poly(meth)acrylate ester, and various commercial polymers may be employed advantageously. Among these, from the standpoint of optical performance, a cellulose ester is preferable, and a lower fatty acid ester of cellulose is more preferable. The lower fatty acid means a fatty acid containing 6 or less carbon atoms, preferably with 2 carbon atoms (corresponding to cellulose acetate), 3 carbon atoms (cellulose propionate) or 4 carbon atoms (cellulose butyrate). Among these, cellulose triacetate is particularly preferable. Also a mixed ester of fatty acids, such as cellulose acetate propionate or cellulose acetate butyrate, may be utilized. Also a polymer, which is known to easily express a birefringence such as polycarbonate or polysulfone, may also be utilized by reducing such expressing property by means of a molecular modification as described in WO00/26705, pamphlet.

In the following, cellulose esters (particularly cellulose triacetate), preferably employed as the transparent substrate, will be explained in detail. The cellulose ester to be employed preferably has an acetylation degree of from 55.0 to 62.5%, particularly preferably from 57.0 to 62.0%. The acetylation degree means an amount of bonded acetic acid, per unit weight of cellulose, and can be measured and calculated according to a measuring method for acetylation degree by ASTM, D-817-91 (test method for cellulose acetate etc.). The cellulose ester preferably has a viscosity-average degree of polymerization (DP) of 250 or higher, more preferably 290 or higher. Also the cellulose ester to be employed in the invention preferably has a narrower molecular weight distribution Mw/Mn (Mw: weight-average molecular weight, Mn: number-average molecular weight), measured by a gel permeation chromatography. As a specific value, Mw/Mn is preferably within a range of from 1.0 to 4.0, more preferably from 1.3 to 3.5, and further preferably from 1.4 to 3.0.

In cellulose triacetate, the entire substitution degree is not uniformly distributed, by ⅓ each, to the hydroxyl groups in 2-, 3- and 6-positions of cellulose, but the substitution degree has a tendency to become smaller in the 6-position hydroxyl group. It is however preferable that the hydroxyl group in 6-position of cellulose has a substitution degree higher than that in 2- or 3-position. Within the entire substitution degree, the hydroxyl group in 6-position preferably represents a substitution, with an acyl group, of from 30 to 40%, more preferably 31% or higher and particularly preferably 32% or higher. The hydroxyl group in 6-position preferably has a substitution degree of 0.88 or higher. The hydroxyl group in 6-position may be substituted, instead of an acetyl group, with an acyl group containing 3 or more carbon atoms (such as propionyl, butyryl, valeroyl, benzoyl or acryloyl). The substitution degree in each position can be determined by an NMR measurement. A cellulose ester with a high substitution degree in the 6-position hydroxyl group may be synthesized according to methods, described in JP-A-11-5851, Synthetic Example 1 in paragraphs 0043-0044, Synthetic Example 2 in paragraphs 0048-0049, and Synthetic Example 3 in paragraphs 0051-0052.

For regulating the retardation of a polymer film employed as the transparent substrate, particularly a cellulose acetate film, it is possible to utilize an aromatic compound including at least two aromatic rings as the retardation increasing agent. In the case of utilizing such retardation increasing agent, it is employed within a range of from 0.01 to 20 parts by weight with respect to 100 parts by weight of cellulose acetate. The retardation increasing agent is preferably employed within a range of from 0.05 to 15 parts by weight with respect to 100 parts by weight of cellulose acetate, and more preferably from 0.1 to 10 parts by weight. It is also possible to use two or more aromatic compounds in combination. The aromatic ring of the aromatic compound includes an aromatic hetero ring in addition to an aromatic hydrocarbon ring.

In the aromatic compound as the retardation increasing agent, the aromatic hydrocarbon ring is particularly preferably a 6-membered ring (namely benzene ring). Also the aromatic heterocycle is generally an unsaturated heterocycle, which is preferably a 5-, 6- or 7-membered ring and more preferably a 5- or 6-membered ring. The aromatic heterocycle generally contains as many double bonds as possible. A hetero atom is preferably a nitrogen atom, an oxygen atom or a sulfur atom, and a nitrogen atom is particularly preferable. Examples of the heterocycle include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring. As the aromatic ring, a benzene ring, a furan ring, a thiophene ring, a pyrrole ring, an oxazole ring, a thiazole ring, an imidazole ring, a triazole ring, a pyridine ring, a pyrimidine ring, a pyrazine ring or a 1,3,5-triazine ring is preferable, and a benzene ring or a 1,3,5-triazine ring is more preferable. Particularly preferably, the aromatic compound includes at least a 1,3,5-triazine ring. A number of the aromatic rings the aromatic compound has is preferably from 2 to 20, more preferably from 2 to 12, further preferably 2 to 8, and most preferably from 2 to 6.

In the aromatic compound as the retardation increasing agent, a link structure of the two aromatic rings may be classified into (a) condensed ring formation, (b) a direct link by a single bond, and (c) a link via a linkage group (a spiro linkage not possible because of the aromatic character of the rings), and any of these link structures (a) to (c) is acceptable. Such retardation increasing agents are described for example in WO01/88574A1, WO0/2619A1, JP-A-2000-111914, JP-A-2000-275434 and JP-A-2002-363343.

The cellulose acetate as the transparent substrate may be constituted of a single layer or plural layers. For example, in the case of cellulose triacetate, a single-layered cellulose acetate is prepared by a drum casting method disclosed for example in JP-A-7-11055, or a band casting method, and a plural-layered cellulose triacetate film is prepared by so-called co-casting method described for example in JP-A-61-94725 and JP-B-62-43846. Such methods are executed by dissolving flakes of a raw material in a solvent such as a halogenated hydrocarbon (such as dichloromethane), an alcohol (such as methanol, ethanol or butanol), an ester (methyl formate or methyl acetate), or an ether (dioxane, dioxolane or diethyl ether), then adding if necessary various additives such as a plasticizer, an ultraviolet absorber, an antiaging agent, a lubricant or a releasing promoter to obtain a solution (called dope), then casting such dope on a substrate constituted of a horizontal endless metal belt or a rotating drum from dope supply means (called a die), by a single-layer casting of a dope in case of a single-layered film or by a co-casting of a cellulose acylate dope of a high concentration and dopes of a low concentration on both sides thereof, then peeling, from the substrate, a film having a certain rigidity after a drying of a certain extent on the substrate and passing the film by various conveying means through a drying section thereby eliminating the solvent.

For dissolving cellulose triacetate, dichloromethane is employed as a representative solvent. However, in consideration of a global environment or a work environment, the solvent is preferably substantially free from a halogenated hydrocarbon such as dichloromethane. “Substantially free” means that a proportion of the halogenated hydrocarbon in the organic solvent is less than 5 mass % (preferably less than 2 mass %). For preparing a dope of cellulose triacetate with a solvent substantially free from dichloromethane or the like, there is necessitated special dissolving methods as explained in the following. These methods are called a cooled dissolving method and a high-temperature dissolving method. A cellulose acetate film substantially free from a halogenated hydrocarbon such as dichloromethane and a producing method therefor are described in detail in the Japan Institute of Invention and Innovation, Laid-open Technical Report (2001-1745, issued Mar. 15, 2001) (hereinafter abbreviated as Laid-open Technical Report 2001-1745).

As to the additives to be added for improving various physical properties of cellulose acetate, those described in Laid-open Technical Report 2001-1745 may be utilized advantageously.

In the case that the transparent substrate is constituted of cellulose acetate, it is preferably subjected to a saponification process, in order to achieve a sufficient adhesion to another functional layer or another base material for example by an adhesive layer formed on a surface. The saponification process is executed by a known method, such as an immersion of the film in an alkali solution for a suitable time. After the immersion in the alkali solution, the film is preferably washed sufficiently with water or immersed in a dilute acid to neutralize the alkali component in order that the alkali component does not remain in the film. The saponification process renders surfaces of the transparent substrate hydrophilic. The hydrophilic surface is particularly effective for improving an adhesive property to a polarizing film principally constituted of polyvinyl alcohol. Also the hydrophilic surface, retarding deposition of dusts in the air, hinders entry of dusts between the polarizing film and the transparent substrate at the adhesion to the polarizing film and is thus effective for preventing a point-shaped defect caused by dusts.

The saponification process is preferably executed in such a manner that a surface of the transparent substrate has a contact angle to water of 40° or less, more preferably 30° or less and particularly preferably 20° or less.

A specific method of the alkali saponification process may be selected from following methods (1) and (2). The method (1) is superior in that the process can be executed in the same manner as in the ordinary cellulose acetate film, but saponifies also the surface of the optically anisotropic layer, thus possibly leading to defects that the film is deteriorated by an alkaline hydrolysis of the surface and that a stain may be formed by the eventually remaining saponifying solution. In such case, the method (2) is superior though it requires a particular process:

(1) After the optically anisotropic layer is formed on the transparent substrate, the film is immersed at least once in an alkali solution whereby a rear surface of the film is saponified:

(2) Before or after the optically anisotropic layer is formed on the transparent substrate, an alkali solution is coated on a surface of the antireflection film, opposite to a surface thereof bearing the optically anisotropic layer, then heated, washed with water and/or neutralized whereby the film is saponified only on the rear surface thereof.

Also, the cellulose acetate film preferably has a surface energy of 55 mN/m or higher, and more preferably within a range of from 60 to 75 mN/m. A surface energy of a solid can be determined, as described in Basics and Application of Wetting, Realize Co., published Dec. 10, 1989, by a contact angle method, a wet-heat method or an adsorption method. In the cellulose acetate film of the invention, a contact angle method is employed preferably. More specifically, two solutions with known surface energies are dropped on the cellulose acetate film, and, at a crossing point of the surface of the liquid drop and the film surface, an angle formed between a tangential line to the liquid drop and the film surface and containing the liquid drop is defined as a contact angle, from which the surface energy of the film can be calculated.

The cellulose acetate film has a thickness preferably within a range of from 5 to 500 μm, more preferably within a range of from 20 to 250 μm, further preferably within a range of from 30 to 180 μm, and particularly preferably within a range of from 30 to 110 μm.

(Retardation Plate)

A retardation plate of the invention includes, on a transparent substrate, at least an optically anisotropic layer formed by a liquid crystal composition containing a liquid crystal compound a chiral agent. The liquid crystal compound constituting the optically anisotropic layer is preferably in a state containing little defects. For this purpose, the liquid crystal composition is preferably aligned on a transparent substrate, provided with an alignment film for controlling the alignment.

A retardation plate of the invention is prepared, in order to fix the liquid crystal composition without deteriorating an alignment state in a liquid crystal state thereof, by executing a heating once to a temperature at which a liquid crystal phase is formed, and then executing a cooling while maintaining the aligned state, thereby forming the optically anisotropic layer. Otherwise it is prepared by heating a liquid crystal composition, containing a liquid crystal compound having a polymerizable group and a polymerization initiator, to a liquid crystal phase-forming temperature, then executing a polymerization and a cooling. The “fixed state” as used herein indicates most typically and preferably a state where the alignment of the liquid crystal compound, contained in the optically anisotropic layer, is retained, but the invention is not limited to such state, and it further includes a state in which the optically anisotropic layer does not show a fluidity and the aligned state is not changed by an external field or an external force, normally within a range of from 0 to 50° C., or, as a stricter condition, within a range of from −30 to 70° C., whereby the fixed alignment state is stably retained.

In a retardation plate of the invention, when the optically anisotropic layer is finally formed, the liquid crystal compound needs no longer to show a liquid crystalline property as long as the optical anisotropy is retained. As an example, a biaxial liquid crystal compound of a low molecular weight, having a group reactive by heat or a light, may be polymerized or crosslinked by heat or a light to assume a high molecular weight, in which the liquid crystalline property may be lost.

The optically anisotropic layer formed by the liquid crystal composition preferably has a thickness (film thickness obtained after evaporation of a solvent and the like contained in the liquid crystal composition) within a range of from 0.1 to 20 μm, more preferably from 0.2 to 15 μm, and most preferably from 0.3 to 10 μm.

A retardation plate of the invention is preferably formed by a chiral nematic phase. In the chiral nematic phase, a helical axis is preferably so aligned as to be substantially perpendicular to a planar direction of the transparent substrate.

A thin film of a chiral nematic phase with a fixed alignment is known to show a selective reflection, and a selective reflection is also confirmed in the retardation plate of the invention. A wavelength range of such selective reflection may be selected according to the purpose of the retardation plate. A central wavelength λ(nm) of the wavelength range of the selective reflection can be represented by λ=n·P, wherein n is an average refractive index of the liquid crystal composition, and P is a helical pitch (nm) of the chiral nematic phase. Since P generally decreases with an increase in the amount of the chiral agent, the wavelength range of selective reflection can be controlled by the amount of the chiral agent.

In a retardation plate of the invention, the wavelength range of selection reflection of the optically anisotropic layer may be in an infrared region, a visible region or an ultraviolet region. For example, in the case of utilizing the retardation plate of the invention in an application which positively utilizes a coloration, such as a color filter, the wavelength range of selective reflection is preferably present in the visible region. Also in the case of application as a retardation plate of a negative C-plate, the wavelength range of selective reflection is preferably present in the ultraviolet region.

In the application for a negative C-plate, the wavelength range of selective reflection has an upper limit of 350 nm or less, preferably 300 nm or less. On the other hand, the wavelength range of selective reflection has a lower limit of 50 nm or more, preferably 100 nm or more.

A retardation plate of the invention may be applied to a transmission-type liquid crystal display apparatus in combination with a polarizing film, for the purpose of expanding a viewing angle of the liquid crystal display apparatus. In the following, a liquid crystal display apparatus utilizing the retardation plate of the invention will be explained.

(Liquid Crystal Display Apparatus)

A retardation plate of the invention allows to provide a liquid crystal display apparatus with an expanded viewing angle. A retardation plate (optical compensation sheet) for a TN mode liquid crystal cell is described in JP-A-6-214116, U.S. Pat. Nos. 5,583,679 and 5,646,703, and GP 3911620A1. Also a retardation plate (optical compensation sheet) for a IPS or FLC mode liquid crystal cell is described in JP-A-10-54982. Also a retardation plate (optical compensation sheet) for an OCB or HAN mode liquid crystal cell is described in U.S. Pat. No. 5,805,253 and WO96/37804 pamphlet. Also a retardation plate (optical compensation sheet) for an STN mode liquid crystal cell is described in JP-A-9-26572. Also a retardation plate (optical compensation sheet) for a VA mode liquid crystal cell is described in Japanese Patent No. 2866372.

Retardation plates (optical compensation sheets) for the liquid crystal cells of various modes may be prepared by referring to the patent references above. A retardation plate of the invention is applicable to the liquid crystal display apparatus of various modes, such as TN (twisted nematic), IPS (in-plane switching), FLC (ferroelectric liquid crystal), OCB (optically compensatory bend), STN (super twisted nematic), VA (vertically aligned) and HAN (hybrid aligned nematic). As an example, application of a retardation plate having an inverse wavelength dispersion to a VA mode display is described in JP-A-2004-46163. Therefore, a retardation plate, prepared with the liquid crystal compound of the invention having an inverse wavelength dispersion property, is anticipated to provide similar effects in the VA mode display.

A liquid crystal composition of the invention is not particularly restricted in the application therefor, and can be advantageously utilized in a retardation plate and an elliptic polarizing plate, also in optical elements such as a polarizing plane rotating plate, and a PS conversion prism. The retardation plate utilizing the liquid crystal composition of the invention is not particularly restricted in the application, and can be advantageously utilized in an optical analysis apparatus, an optical measuring apparatus, an optical pickup device, a reflective liquid crystal device, a semi-transmission liquid crystal device and a transmission liquid crystal device.

### EXAMPLES

### Synthesis Example 1

### Synthesis of G-1

Synthesis can be executed according to the following scheme.

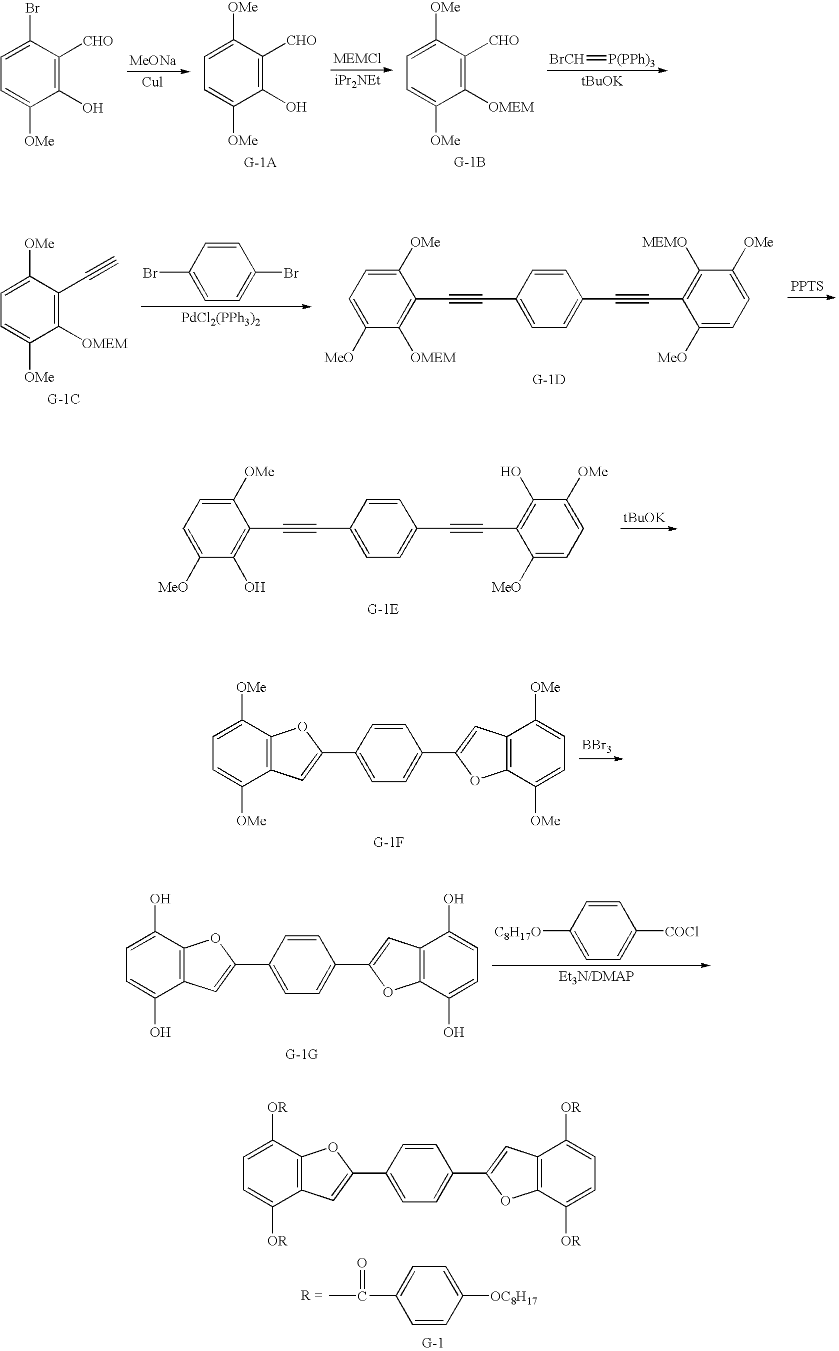

(Synthesis of G-1a)

10.2 g of 6-bromo-2-hydroxy-3-methoxybenzaldehyde were dissolved in 40 ml of dimethylformamide, then 50 g of sodium methoxide (28% methanol solution) and 0.8 g of copper iodide were added, and the mixture was agitated at 95° C. for 8 hours. After cooling, water was added, and the mixture was extracted with ethyl acetate. The obtained organic layer was concentrated to dry under a reduced pressure to obtain 7.4 g of G-1A in crystals.

(Synthesis of G-1B)

100 ml of dichloromethane were added to 7.4 g of G-1A and 11 ml of diisopropylethylamine, and 7.0 ml of 2-methoxyethoxymethyl chloride (MEMCl) were dropwise added at an internal temperature of 30° C. or lower. After agitation for 5 hours at the room temperature, water was added, and the mixture was extracted with dichloromethane. The organic layer was concentrated under a reduced pressure, and was purified by a column chromatography to obtain 10.0 g of G-1B.

(Synthesis of G-1C)

27.5 g of bromomethyltriphenylphosphonium bromide were suspended in 100 ml of tetrahydrofuran, then 10.5 g of t-BuOK were added and the mixture was agitated for 1 hour. 8.5 g of G-1B, dissolved in 30 ml of tetrahydrofuran, were dropwise added to the reaction liquid, which was further agitated for 2 hours at the room temperature, and 13 g of t-BuOK were further added. After agitation at 50° C. for 1 hour, water was added and the mixture was extracted with ethyl acetate. The organic layer was concentrated under a reduced pressure, and was purified by a column chromatography to obtain 3.2 g of G-1C.

(Synthesis of G-1D)

2.6 g of G-1C, 1.05 g of 1,4-dibromobenzene, 100 mg of triphenylphosphine, 50 mg of bis(triphenylphosphine) palladium (II) dichloride and 10 mg of copper (I) iodide were dissolved in 100 ml of triethylamine, and refluxed for 10 hours under a nitrogen atmosphere. After cooling, water was added to the reaction liquid, which was then extracted with ethyl acetate and the extracted was washed with a saturated sodium chloride solution. The organic layer was concentrated under a reduced pressure, and was purified by a column chromatography to obtain 2.8 g of G-1D.

(Synthesis of G-1E)

2.8 g of G-1D and 0.6 g of pyridinium-paratoluenesulfonic acid (PPTS) were dissolved in 100 ml of ethanol, and were refluxed for 12 hours under a nitrogen atmosphere. After cooling, water was added to the reaction liquid, which was then extracted with ethyl acetate, and the extract was washed with a saturation sodium chloride solution. The obtained organic layer was concentrated to dry under a reduced pressure to obtain 1.9 g of G-1E.

(Synthesis of G-1F)

1.9 g of G-1E and 1.5 g of t-BuOK were dissolved in 70 ml of ethanol, and were refluxed for 12 hours under a nitrogen atmosphere. After cooling, precipitated crystals were separated by filtration and dried to obtain 1.6 g of G-1F.

(Synthesis of G-1G)

1.6 g of G-1F were dissolved in 100 ml of dichloromethane, then 100 ml of boron tribromide (as 1.0M solution in dichloromethane) were added, and the mixture was refluxed for 10 hours. After cooling, water was added to the reaction liquid, and precipitating crystals were separated by filtration and dried to obtain 1.1 g of G-1G.

(Synthesis of G-1)

0.1 g of G-1G and 0.43 g of 4-octyloxybenzoyl chloride were dissolved in 10 ml of tetrahydrofuran, and 0.25 ml of triethylamine and 0.01 g of 4-dimethylaminopyridine were added. After agitation for 12 hours at the room temperature, 100 ml of methanol were added to the reaction liquid, and precipitating crystals were separated by filtration. The obtained crystal were further purified by a column chromatography to obtain 0.25 g of G-1 in crystals. The obtained G-1 showed following N spectra:

¹H-NMR (solvent: CDCl₃, control: tetramethylsilane), δ (ppm)

0.91 (12H, t)

1.20-1.40 (32H, m)

1.40-1.60 (8H, m)

1.80-1.90 (8H, m)

4.07 (8H, t)

7.01 (10H, m)

7.12 (2H, d)

7.19 (2H, d)

7.78 (4H, s)

8.22 (4H, d)

8.27 (4H, d)

Phase changes of the obtained G-1 were measured by observing the texture under a polarization microscope. In the course of a temperature elevation, it changed from a crystalline phase to a nematic phase at about 210° C., and further changed to an isotropic liquid phase when the temperature exceeded 250° C. Thus, G-1 expresses a nematic phase in a range of from 210 to 250° C.

(Measurement of Wavelength Dispersion Property)

G-1 was poured in a wedge-shaped liquid crystal cell (N-wedge NLCD-057, manufactured by Nippo Denki Co., Ltd.) at 260° C., and subjected to measurements of Δn values at 450, 550 and 650 nm at 220° C. to obtain Δn(450 nm)=0.055, Δn(550 nm)=0.060 and Δn(650 nm)=0.063. Thus, there were confirmed Δn(450 nm)/Δn(550 nm)=0.92 and Δn(650 nm)/Δn(550 nm)=1.05.

### Synthesis Example 2

### Synthesis of G-2

Synthesis can be executed according to the following scheme.

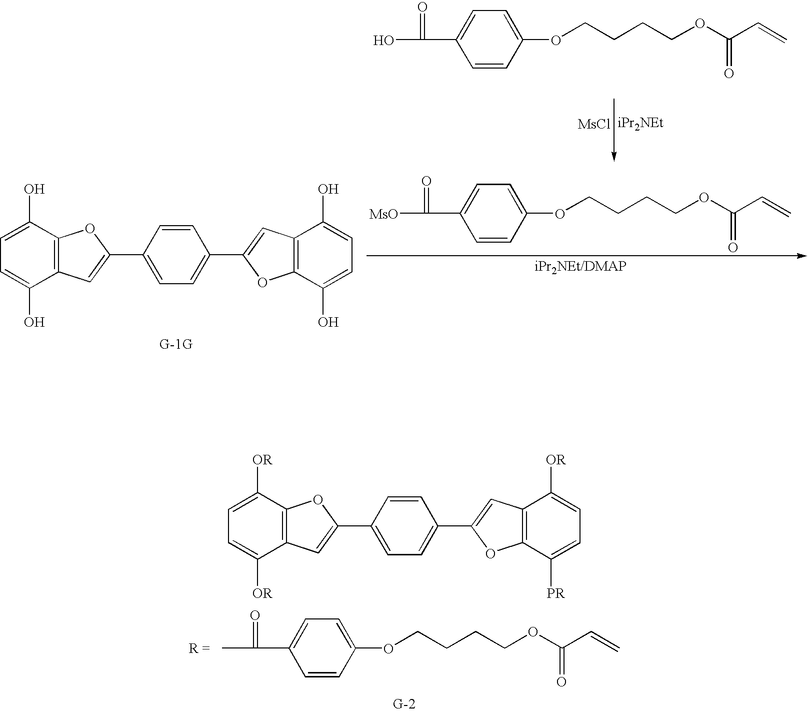

0.43 g of methanesulfonyl chloride were dissolved in 10 ml of tetrahydrofuran, and the solution was cooled to 0° C. 1.0 g of 4-(4-acryloyloxybutyloxy)benzoic acid, and 10 ml of a tetrahydrofuran solution of 0.51 g of diisopropylethylamine were dropwise added to the solution. After agitation for 1 hour at 0° C., 0.51 g of diisopropylethylamine and 0.02 g of 4-dimethylaminopyridine were added, and 10 ml of a tetrahydrofuran solution of 0.14 g of G-1G, prepared according to the synthesis example 1, were added. After agitation for 12 hours at the room temperature, 100 ml of methanol were added to the reaction liquid, and the precipitating crystals were separated by filtration. The obtained crystals were dried and purified by a column chromatography to obtain 0.22 g of G-2 as crystals. The obtained G-2 showed following NMR spectra:

¹H-NMR (solvent: CDCl₃, control: tetramethylsilane), δ (ppm)

1.90-2.00 (16H, m)

4.12-4.16 (8H, m)

4.27-4.31 (8H, m)

5.83 (4H, dd)

6.13 (4H, dd)

6.42 (4H, dd)

6.98 (2H, s)

7.01 (4H, d)

7.03 (4H, d)

7.14 (2H, d)

7.20 (2H, d)

7.78 (4H, s)

8.24 (4H, d)

8.26 (4H, d)

Phase changes of the obtained G-2 were measured by observing the texture under a polarization microscope. In the course of a temperature elevation, it changed from a crystalline phase to a nematic phase at about 180° C., and further changed to an isotropic liquid phase when the temperature exceeded 250° C. Thus, G-2 expresses a nematic phase in a range of from 180 to 250° C.

(Measurement of Wavelength Dispersion Property)

(Preparation of Aligned Film)

G-2 (50 mg) and a following additive SH-1 (0.2 mg) were dissolved in 0.5 ml of chloroform, and were spin coated on a glass plate bearing an alignment film described in following Example 1. The prepared sample was heated to 190° C. on a hot stage (MP200DMSH, manufactured by Kitazato Supply Co.) and subjected to measurements of retardations by KOBRA-WR (manufactured by Oji Keisoku Kiki Co.). Based on a film thickness separately determined, Δn values were determined as Δn(450 nm)=0.057, Δn(550 nm)=0.063 and Δn(650 nm)=0.066. Thus, there were confirmed Δn(450 nm)/Δn(550 nm)=0.91 and Δn(650 nm)/Δn(550 nm)=1.05.

### Example 1

### Preparation of Liquid Crystal Composition

A liquid crystal compound G-2 of the invention (100 mg), a polymerization initiator (3 mg) (Irgacure 907, manufactured by Nippon Ciba-Geigy Ltd.), a sensitizer (1 mg) (Kayacure DETX, manufactured by Nippon Kayaku Co.) and a following chiral agent K-1 (1 mg) were dissolved in 0.5 ml of chloroform, then coated on a glass plate, and subjected to a texture observation under heating. As a result, the liquid crystal composition of the invention was confirmed to express a chiral nematic phase.

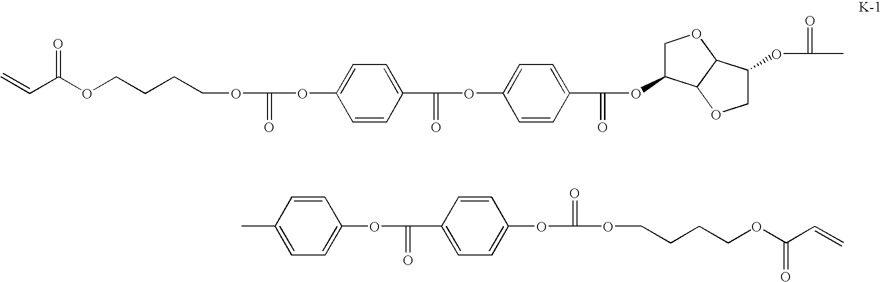

(Preparation of Retardation Plate Utilizing Polymerizable Liquid Crystal Compound)

(Preparation of Alignment Film)

A polyimide-type liquid crystal aligning material (SE-150, manufactured by Nissan Chemical Industries Ltd.) was diluted with γ-butyrolactone and coated on a glass plate. After drying at 80° C. for 15 minutes, it was heated at 250° C. for 60 minutes and, after cooling, subjected to a rubbing treatment to obtain an alignment film. The obtained alignment film had a thickness of 0.1 μm.

(Preparation of Optically Anisotropic Layer)

A liquid crystal compound G-2 of the invention (100 mg), a polymerization initiator (3 mg) (Irgacure 907, manufactured by Nippon Ciba-Geigy Ltd.), a sensitizer (1 mg) (Kayacure DETX, manufactured by Nippon Kayaku Co.), the aforementioned chiral agent K-1 (10 mg) and a following additive SH-1 (0.4 mg) were dissolved in 0.5 ml of chloroform, and coated on the aforementioned alignment film. It was heated to 200° C., and then subjected to an ultraviolet irradiation of 400 mJ/cm² in a nitrogen atmosphere to fix the alignment state of the optically anisotropic layer. It was then let to spontaneously cool to the room temperature, thereby obtaining a retardation plate. The formed optically anisotropic layer had a thickness of 2.0 μm. On the prepared retardation plate, Δn was obtained by measuring Rth, by measuring retardation with KOBRA (manufactured by Oji Keisoku Kiki Co.) with different observation angles at wavelengths of 450, 550 and 650 nm and dividing such Rth by a separately determined film thickness (d).

As a result, Δn(450 nm)=0.061, Δn(550 nm)=0.067 and Δn(650 nm)=0.070 were obtained. Thus, there were confirmed Δn(450 nm)/Δn(550 nm)=0.91 and Δn(650 μm)/Δn(550 nm)=1.04.

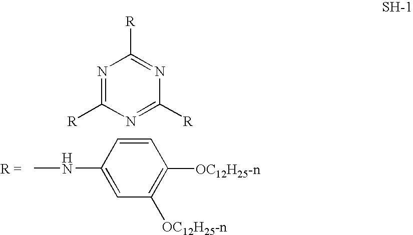

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-185270, filed Jun. 24 of 2005, the contents of which are incorporated herein by reference.

1. A liquid crystal composition comprising: a liquid crystal compound; and a chiral agent, wherein the liquid crystal compound has an intrinsic birefringence Δ(λ) at a wavelength λ, and the intrinsic birefringence Δ(λ) satisfies formula (1):
Δn(450 nm)/Δn(550 nm)<1.0

2. The liquid crystal composition according to claim 1, wherein the liquid crystal composition expresses a chiral nematic phase.

3. The liquid crystal composition according to claim 1, wherein the liquid crystal compound is a compound represented by formula (I): 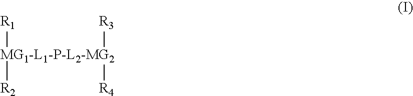
wherein
MG₁ and MG₂ each independently represents a liquid crystal core inducing expression of a liquid crystal phase and comprising two to eight cyclic groups, the two to eight cyclic groups comprising at least one of an aromatic ring, an aliphatic ring and a heterocycle;
R₁, R₂, R₃ and R₄ each independently represents a substituent group, dipole function group or hydrogen bonding group, which is substituted in a molecular longitudinal axial direction of the liquid crystal core and induces expression of the liquid crystal phase;
L₁ and L₂ each independently represents a linkage group substituted on the liquid crystal core MG₁ and is represented by formula (I)-LA or (I)-LB: 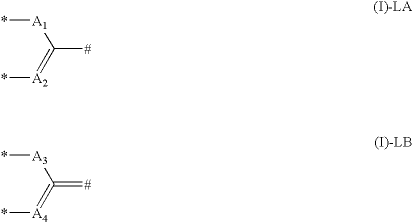
wherein * represents a substituting position on one of the two to eight cyclic groups of MG₁ or MG₂, # represents a connecting position to P, A₁, A₃ and A₄ each independently represents —O—, —NH—, —S—, —CH₂—, —CO—, —SO—, or —SO₂—, A₂ represents —CH═ or —N═;
in a case where both of L₁ and L₂ are represented by the formula (I)-LA, P represents a divalent linkage group selected from the group consisting of —CH═CH—, —C≡C—, 1,4-phenylene and a combination thereof, or a single bond;
in a case where one of L₁ and L₂ is a group represented by the formula (I)-LB and the other of L₁ and L₂ is a group represented by the formula (I)-LA, P represents *═CH—P₁-# or *═N—P₁-#, wherein * indicates a connecting position with the group represented by the formula (I)-LB, # indicates a connecting position with the group represented by the formula (I)-LA, and P₁ represents a divalent linkage group selected from the group consisting of —CH═CH—, —C≡C—, 1,4-phenylene and a combination thereof, or a single bond; and
in a case where both of L₁ and L₂ are represented by the formula (I)-LB, P represents a double bond, ═CH—P₁—CH═, ═N—P₁—CH═, or ═N—P₁—N═.

4. The liquid crystal composition according to claim 3, wherein the compound represented by formula (I) is a compound represented by formula (II): 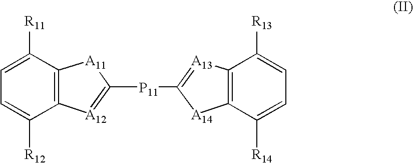
wherein A₁₁ and A₁₄ have the same meaning as A₁ in the formula (I); A₁₂ and A₁₃ have the same meaning as A₂ in the formula (I); P₁₁ has the same meaning as P₁ in the formula (I); and R₁₁, R₁₂, R₁₃ and R₁₄ each independently is represented by formula (III):
*-L₁₁-Q (III)
wherein * indicates a bonding position to the benzene ring in the formula (II); L₁₁ represents a divalent linkage group; and Q represents a polymerizable group or a hydrogen atom.

5. A retardation plate comprising: a transparent support; and an optically anisotropic layer, wherein the optically anisotropic layer formed from a liquid crystal composition according to claim 1.

6. The retardation plate according to claim 5, wherein the optically anisotropic layer is formed from the liquid crystal composition in a chiral nematic phase, and the chiral nematic phase has a chiral helical axis substantially perpendicular to a planar direction of the transparent substrate.

7. The retardation plate according to claim 5, wherein the optically anisotropic layer show a selective reflection in a wavelength range of an ultraviolet wavelength region.

8. The retardation plate according to claim 7, wherein the ultraviolet wavelength region of the selective reflection is from 50 to 350 nm.

9. The retardation plate according to claim 5, wherein the optically anisotropic layer has a film thickness of 0.1 to 20 μm.
